(19) United States
(12) Patent Application Publication
(10) Pub. No.: US 2019/0069542 A1
(43) Pub. Date: Mar. 7, 2019

(54) COMPOSITIONS AND METHODS FOR REPELLING AND KILLING TICKS AND DETACHMENT OF FEEDING TICKS

(71) Applicants: EVOLVA SA, REINACH (CH); CENTERS FOR DISEASE CONTROL AND PREVENTION, Bethesda, MD (US)

(72) Inventors: Bryan N. Julien, Lexington, KY (US); Marc C. Dolan, Wellington, CO (US); Roderick Stephen Bradbury, North Saanich (CA)

(21) Appl. No.: 16/086,461

(22) PCT Filed: Mar. 24, 2017
(86) PCT No.: PCT/EP2017/057137

§ 371 Date: Sep. 19, 2018

Related U.S. Application Data
(60) Provisional application No. 62/312,985, filed on Mar. 24, 2016.

(51) Int. Cl. A01N 35/06

(52) U.S. Cl. CPC A01N 35/06

(57) ABSTRACT

Methods for repelling and killing ticks as well as for detaching attached and feeding ticks from the skin of a subject by application of a composition comprising nootkatone to the tick are disclosed.

### CROSS-REFERENCE TO RELATED APPLICATIONS

This application claims the benefit of U.S. Provisional Patent Application No. 62/312,985, filed Mar. 24, 2016, which is incorporated by reference herein in its entirety.

### BACKGROUND OF THE INVENTION

### Field of the Invention

This disclosure relates generally to the use of nootkatone as a pest control agent. In particular, this disclosure relates to the use of nootkatone for repelling ticks, detachment of ticks, and killing attached and feeding ticks.

### Description of Related Art

Many insects, parasites, and other pests are undesirable to humans, domesticated animals, and pets because they'cause pain, discomfort, and often serve as vectors for disease. Examples of such pests include ticks. The blacklegged tick, also known as the deer tick (Ixodes scapularis), is the principal vector of Lyme disease spirochetes, the agent causing human granulocytic anaplasmosis, and human babesiosis. Indeed, Lyme disease is the most commonly reported vector-borne disease in the United States. The first line of defense against vector-borne diseases is personal protection.

To combat these pests, repellents and pesticides are often recommended and used but have their limitations. For example, DEET (N,N-Diethyl-meta-toluamide) is effective for repelling insects and nuisance pests, such as deer ticks and cat fleas. However, DEET is perceived by many to have a strong “chemical” smell at the concentrations usually used in most formulations, which cannot be remedied by lowering the DEET concentration because this compound is less effective in low concentrations. In addition, DEET is a known plasticizer and people dislike the oily feel. Moreover, DEET is not recognized as being effective in removing attached and feeding ticks. In addition to DEET, examples of compounds that have been used to repel or kill pests include synthetic pyrethroids such as permethrin, carbamates, and chlorinated hydrocarbons such as lindane. There is a movement towards all natural alternatives and away from synthetic pesticides and repellents, with the perception being all natural products are safer to use and may have more desired effects. As well, organic insecticides and inorganic salts are known in the art for their ability to repel or kill insects and other pests (e.g., see U.S. Pat. Nos. 2,423,284, 4,308,279, 4,376,784, 4,948,013, 5,434,189 and 6,048,892). Although some of these chemicals can be effective as pesticides, not all are approved for direct or indirect contact with animals, including humans, nor have any been recognized as being effective in detaching ticks.

Natural pesticides offer an alternative to synthetic pesticides and are considered generally safer for humans and the environment. Examples of natural pest repellents or pesticides include natural or synthetic oils of camphor, cedarwood, citronella, eucalyptus, pennyroyal, and the pyrethrins. Though, such natural pesticides also have their disadvantages. For example, plant oils tend to be expensive to isolate in commercial quantities and usually are very volatile, evaporating quickly when applied to a surface such as skin or exposed to the elements. Also, there are reports that some pests are developing a resistance to certain natural pesticides. For example, it is reported that some bedbugs have developed a resistance to pyrethrins and pyrethroids. Resistance to pesticides in arthropods is reportedly widespread, with at least 400 species being resistant to one or more insecticides (U.S. Pat. No. 5,571,901).

In addition, some natural pesticides have unintended effects on animals. For example, application of some pyrethrins can cause skin problems, asthma, headache, nausea, sneezing, and/or vomiting (e.g., see U.S. Department of Labor, Chemical Sampling Information—Pyrethrin (2006)).

Moreover, while some repellents and pesticides are effective at repelling pests such as ticks, if they are not 100% effective during their intended or expected duration of use, the subject is presented with a difficult problem. Once a tick is attached to an animal or human, repellents and pesticides are of little to no help. While ticks do not “embed” while feeding, their mouths consist primarily of a hypostome, which is a hard, straw-like structure that has backward facing projections (like shark teeth) which make it difficult to remove. For this reason, people with ticks or that must remove them from an animal cannot remove them easily, because inter alia mechanical removal often results in killing the tick and leaving some portion of the tick embedded in the skin, increasing the chances of a bacterial infection. Therefore, common methods for removing ticks often consist of using heat (e.g., a lit cigarette or a match) to force the tick to detach from the skin. However, such approaches are dangerous, inefficient and are highly undesirable.

Thus, new natural compositions are needed to kill and/or repel pests such as ticks that are both safe and effective. But of even greater importance would be the discovery of a natural composition that detaches ticks from skin.

### SUMMARY OF THE INVENTION

Provided herein are safe and effective natural compositions that repel ticks and cause feeding ticks to detach from skin or kill in situ (while feeding).

In a first aspect, the invention provides a method of detaching a tick attached to skin of a subject, the method including the steps of applying a therapeutically effective amount of nootkatone to the attached tick and detaching the tick from the skin of the subject.

In a second aspect, the invention provides a method of preventing tick attachment, or for detaching or killing attached and feeding ticks from skin of an animal including applying a therapeutically effective amount of a nootkatone-containing composition to the animal. The composition comprises nootkatone ex valencene. In one embodiment of the second aspect, nootkatone is applied to an exterior surface of the animal. For example, the exterior surface is one or more of fur, hair, skin, hide, or scalp. In another embodiment of the second aspect, the method further includes the step of removing the tick from the skin of the animal. In a further embodiment of the second aspect, the method further includes applying the nootkatone-containing composition to the tick.

In a third aspect, the invention provides a method for preventing the attachment of a tick to the skin of a subject including the steps of applying a composition comprising a therapeutically effective amount of nootkatone formulated for topical administration to the skin of the subject and preventing the attachment of a tick that contacts the skin of the subject.

In a fourth aspect, the invention provides a method for detaching a tick from skin, the method including the steps of providing a composition comprising at least 2% nootkatone formulated for topical administration, applying the composition to a tick attached to a subject's skin, and detaching the tick from the skin.

In a fifth aspect, the invention provides a method for removing a tick attached to a subject's skin. The method includes providing a composition comprising at least 2% nootkatone formulated for topical administration and applying the composition to the subject's skin. Application of the composition to the skin causes the attached tick to detach from the skin.

In one embodiment of any of the preceding aspects or embodiments, the composition comprising nootkatone is an aerosol, a solution, an emulsion, an oil, a lotion, a soap, a shampoo, a conditioner, a spray, a gel, a cosmetic, a perfume, or a cologne. In another embodiment of any of the preceding aspects or embodiments, the composition comprising nootkatone formulated for topical administration comprises a carrier. For example, the carrier includes an aqueous liquid carrier, water, a gel, a powder, a zeolite, a cellulosic material, a microcapsule, an alcohol such as ethanol, a hydrocarbon, a fat, and/or an oil, and mixtures thereof. In another embodiment of any of the preceding aspects or embodiments, the composition comprising nootkatone includes one or more of a fragrance, a preservative, a propellant, a pH buffering agent, a colorant, a surfactant, an emulsifier, a solvent, an antibiotic, an analgesic, and/or a salt, and mixtures thereof.

In a sixth aspect, the invention provides a method of preventing tick attachment to or detaching a tick from skin of an animal including applying a composition to the animal, the composition comprising from about 0.01% to about 75% nootkatone, 0 to about 30% additional active ingredient, 0 to about 50% additive, and a carrier. In one embodiment of the sixth aspect, the composition includes at least about 2% to about 10% nootkatone. In another embodiment of the sixth aspect, the composition includes about 1% to about 30% of an additional active ingredient. In a further embodiment of the sixth aspect, the composition includes about 1% to about 50% of an additive. For example, the additive is one or more of an antibiotic and an analgesic.

In one embodiment of any of the preceding aspects or embodiments, the animal is a human, a mammal, a bird, or a reptile.

In an seventh aspect, the invention provides a method of detaching a parasite from a surface including applying a formulation comprising at least 2% nootkatone to the surface, wherein the parasite has been attached to the surface for a period of time longer than about 10 minutes.

In an eighth aspect, the invention provides a composition for detaching ticks from a human or animal, the composition including about 2% to about 75% nootkatone, 0 to about 30% of an additional active ingredient, 0 to about 50% of an additive, and a carrier. In one embodiment of the eighth aspect, the composition includes at least about 2% nootkatone. In one embodiment of the eighth aspect, the composition comprises about 1% to about 30% of an additional active ingredient. In a further embodiment of the eighth aspect, the composition includes about 1% to about 50% of an additive. For example, the additive is one or more of an antibiotic and an analgesic. In one embodiment of the eighth aspect, the composition is a 2% nootkatone lotion. In one embodiment of the eighth aspect, the composition is a 2% nootkatone soap. The 2% nootkatone soap can include glycerin. In one embodiment of the eighth aspect, the composition includes 2% nootkatone and 98% carrier. In one embodiment of the eighth aspect, the carrier includes ethanol.

In additional aspects, a composition comprising nootkatone may subsequently be applied to a repelled or detached tick to kill the repelled or detached tick. Such compositions may comprise higher concentrations of nootkatone and/or additional active agents, or be of a different formulation to the nootkatone-containing composition formulated for topical administration to a human or animal, or to a nootkatone-containing pharmaceutical composition suitable for ingestion by the subject. In an additional aspect, is provided a kit of parts comprising a nootkatone-containing composition formulated for topical administration (such as a spray, lotion, shampoo or soap) and a composition comprising nootkatone suitable for killing ticks.

In one embodiment according to any of the preceding aspects or embodiments, the nootkatone is nootkatone ex valencene.

In one embodiment according to any of the preceding aspects or embodiments, the nootkatone is bergapten-free.

In one embodiment according to any of the preceding aspects or embodiments, the nootkatone is limonene-free.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### DESCRIPTION OF DRAWINGS

The following detailed description of the embodiments of the present invention can be best understood when read in conjunction with the following drawings:

FIG. 1 illustrates a biosynthetic pathway for producing nootkatone.

FIG. 2 is a photograph of a human finger assay using a nootkatone-containing formulation to determine efficacy of nootkatone space spray, soap, and cream formulations of Example No. 1.

FIG. 3A is a photograph of a glass shell vial placed on a roller to evaporate acetone from test compositions.

FIG. 3B is photograph of a glass shell vial with acetone evaporated to leave a thin layer of nootkatone (positive control) or soap, lotion, or spray formulations.

FIG. 4 is a photograph of a glass shell vial containing a test composition to which ticks and a cap have been added.

FIG. 5 is a photograph of a tick feeding capsule attached to a mouse. A tick feeding capsule 10 is attached to a portion of the mouse that has been shaved. The capsule 10 is attached to the mouse using easily removable glue made from tree resin and bees wax.

FIG. 6 is GC-FID chromatogram overlay of Frutarom® nootkatone (i.e., citrus-derived nootkatone) and the nootkatone (NxV) used for formulation and tick-drop off studies described herein (see Examples below).

FIG. 7 is a GC-MS NIST library match of an unknown peak in Frutarom® nootkatone. The peak was identified as limonene. No limonene was found in the nootkatone used in the present application.

### DETAILED DESCRIPTION

All publications, patents and patent applications cited herein are hereby expressly incorporated by reference in their entirety for all purposes.

Before describing the present invention in detail, a number of terms will be defined. As used herein, the singular forms “a,” “an,” and “the” include plural referents unless the context clearly dictates otherwise. For example, reference to “an active ingredient” means one or more active ingredients.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

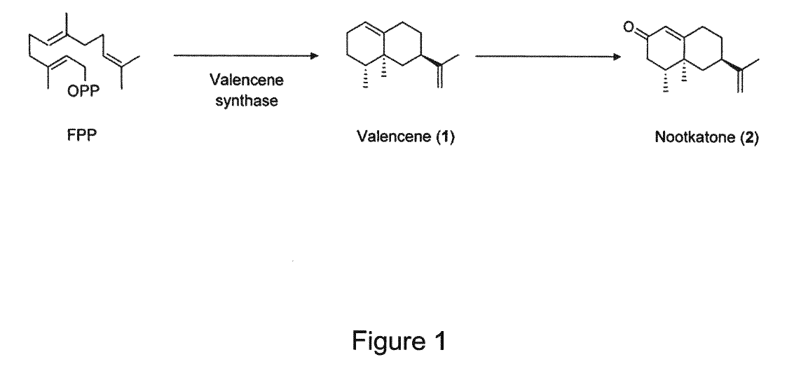

As used herein, the term “nootkatone” refers to a compound seen in FIG. 1 that may be synthesized, isolated, and purified from of a mixture of products produced in a host modified to express enzymes of the nootkatone biosynthetic pathway or that can be produced from naturally occurring sources, such as citrus plants. “Nootkatone” also refers to a mixture of chemical compounds containing or enriched for the nootkatone compound and derived from a modified host, such as a microorganism, or isolated or derived from plant extracts. “Nootkatone” further refers to derivatives and analogs thereof. For example, the nootkatone compound contemplated for use herein may be produced in vivo through expression of one or more enzymes involved in the nootkatone biosynthetic pathway in a recombinant yeast or in vitro using isolated, purified enzymes involved in the nootkatone biosynthetic pathway, such as those described in U.S. Patent Application Publication Nos. 2015/0007368 and 2012/0246767. Therefore, nootkatone as defined herein can differ chemically from other sources of nootkatone, such as extracts from plants and derivatives thereof, or may include such plant extracts and derivatives thereof.

As used herein, the term “nootkatone ex valencene” refers to nootkatone derived from oxidation of valencene that was produced by fermentation, such as by microorganisms harboring one or more valencene synthases and/or other molecules that catalyze formation of valencene. Further, nootkatone ex valencene refers to a combination of chemical compounds derived from oxidation of a valencene-containing fermentation product produced by culturing microorganisms harboring one or more valencene synthases and/or other molecules that catalyze formation of valencene. Nootkatone ex valencene can be purified to maximize the percent of nootkatone relative to other chemical compounds. For example, nootkatone ex valencene can be less than about 50%, about 50%, about 60%, about 70%, about 80%, about 90%, or about 98% nootkatone.

As used herein, the term “active ingredient” refers to a chemical compound or mixture of chemical compounds that kills and/or repels an insect or a pest, such as a tick and related species.

As used herein, the term “individual” refers to a human.

As used herein, the term “subject” refers to an animal, such as a mammal, bird, or reptile.

As used herein, the term “parasite” refers to biting insects, pests, and ectoparasites. Examples of parasites include insects such as bed bugs and lice, and further include arachnids, such as ticks and mites.

As used herein, the term “about” refers to ±10% of any particular value.

As used herein, the terms “or” and “and/or” are utilized to describe multiple components in combination or exclusive of one another. For example, “x, y, and/or z” can refer to “x” alone, “y” alone, “z” alone, “x, y, and z,” “(x and y) or z,” “x or (y and z),” or “x or y or z.”

Disclosed herein are nootkatone-based compositions and methods of using the compositions that are effective at preventing tick attachment to and detaching ticks from the skin of animals.

As used herein, the term “tick attachment” refers to the sinking of mandibles into the skin of a subject, which is a prerequisite for initiating a blood meal and continuing feeding by the tick. As used herein, the terms “tick detachment” and “detaching a tick from the skin of the subject” are used interchangeably and refer to withdrawal of the tick mandibles from within the skin such that the body, head, and mandibles of the feeding tick remain connected to each other at the time the mandibles are withdrawn from the skin of the subject. The resulting detached tick can then be removed from the surface of skin (such as by brushing off) or may fall off the skin of its own accord. In some embodiments, the effective concentration of nootkatone (such as nootkatone ex valencene) is such that tick detachment may be followed by knock-down and/or death of the tick.

As used herein, the terms “therapeutic amount” or “therapeutically effective amount” can be used interchangeably and refer to an amount of a compound that becomes available through the appropriate route of administration to treat or prevent a tick from climbing, landing on, or attaching to an individual.

As used herein the term “tick infestation” can be used to refer to a state where an individual has one or more ticks on an exterior surface, such as the skin. The one or more ticks can either be attached for feeding or can be walking or resting on the individual.

The compositions provided herein optionally contain a carrier and at least about 0.1%, or at least about 1%, or at least about 2%, or at least about 5%, or at least about 7.5%, or at least about 10%, or greater than about 10%, or greater than about 15%, or greater than about 20%, or greater than about 25%, or greater than about 50% by weight nootkatone. In some applications, nootkatone can be present in an amount that is greater than about 60%, about 70%, about 80%, about 90%, about 95% or about 99% by weight of the composition. In one example, the provided compositions contain nootkatone in an amount at or about 0.001% to at or about 2%, or about 0.01% to at or about 5%, or about 0.01% to at or about 75% by weight of the composition. In another example, a composition may contain nootkatone in an amount of from at or about 1% to at or about 50% by weight of the composition. In another example, a composition may contain nootkatone in an amount of from at or about 5% to at or about 40% by weight of the composition. In another example, a composition may contain nootkatone in an amount of from at or about 10% to at or about 30% by weight of the composition. In another example, a composition may contain nootkatone in an amount of from at or about 15% to at or about 25% by weight of the composition. In another example, a composition may contain nootkatone in an amount of from at or about 1% to at or about 90% by weight of the composition. In another example, a composition may contain nootkatone in an amount of about 10%, or about 15%, or about 20%, or about 25%, or about 30%, or about 50% by weight of the composition. In another example, a composition may contain nootkatone or a combination thereof in an amount of up to 99% by weight of the composition.

In another embodiment, a contemplated formulation may be seen in Table No. 1.

TABLE NO. 1
Contemplated formulation

| Ingredient | Approximate Wt. % |
|---|---|
| Nootkatone | 0.01-75 |
| Additional active ingredients | 0-30 |
| Carrier | 25-99.9 |
| Additives | 0-50 |

In certain embodiments, compositions contemplated herein may include nootkatone and one or more additional active ingredients, such as DEET, a pyrethroid, or any other synthetic or natural insecticide or pesticide or repellent. Further examples of additional active ingredients include, for example, those disclosed in U.S. Pat. Nos. 6,897,244, 7,129,271, 7,629,387, and 7,939,091. An additional active ingredient may also be added to a composition in an amount of about 1% to about 30%, or about 5%, or about 10%, or about 15%, or about 20%, or about 25%, or about 30%, or about 50% by weight of the composition.

In other embodiments, compositions contemplated herein may include nootkatone in combination with one or more additive, such as a fragrance, a preservative, a propellant, a pH buffering agent, a colorant, a surfactant, an emulsifier, a solvent, a salt, an antibiotic, an analgesic, a cleansing agent, a sanitizing agent, and the like. An additive may be added to a composition in an amount of about 1% to about 50%, or about 5%, or about 10%, or about 15%, or about 20%, or about 25%, or about 30%, or about 50% by weight of the composition. In one embodiment, a composition comprising a therapeutically effective amount of nootkatone formulated for topical administration (such as being suitable for methods of detaching attached ticks) may further comprise a cleansing or sanitizing agent to cleanse or sanitize the open wound in the skin of the subject left by the tick.

In another embodiment, compositions contemplated herein may include nootkatone in combination with one or more synergists that increase one or more of repellency, knockdown, lethality, or longevity of effectiveness (residual activity). Examples of synergists include piperonyl butoxide, DMSO, and vanillin.

In other embodiments, compositions may include a carrier, such as an aqueous liquid carrier, water, a gel, a powder, a zeolite, a cellulosic material, a microcapsule, an alcohol such as ethanol, a hydrocarbon, a polymer, a wax, a fat, and/or an oil, and the like. A carrier may be added to a composition in an amount of about 10%, or about 15%, or about 20%, or about 25%, or about 30%, or about 50% by weight of the composition. In some applications, a carrier can be present in an amount that is at or greater than about 60%, about 70%, about 80%, about 90%, about 95%, or about 99% by weight of the composition.

In certain embodiments, a composition may be formulated for application topically on an exterior surface of an individual, for example, to the lips, skin, scalp or hair. For example, the composition may be provided as an aerosol, a solution, an emulsion, an oil, a lotion, a soap, a shampoo, a conditioner, a spray, a gel, a cosmetic, a perfume, or a cologne.

In further embodiments, a composition may be formulated for application onto an exterior surface of an animal, such the fur, hair, skin, hide, and/or scalp of a human, a domesticated animal, livestock, or a pet.

In still further embodiments, a composition may be formulated for ingestion such as may be added to a water reservoir to control mosquito larvae and oral/systemic formulations for small animals that serve as disease reservoirs or companion animals.

In other embodiments, a composition may be formulated for ingestion by an animal to convey parasite repellency through secretion of an active ingredient onto the skin, hair, fur, and the like.

Compositions containing nootkatone to treat or prevent tick infestations in humans (especially children), farm animals (such as sheep, pigs, horses, cows, camels), or companion animals (such as dogs and cats) can be formulated for ingestion as a food supplement, a paste, gel, or syrup that is eaten, or a liquid drench to be given orally. Contemplated compositions can be made in many different forms including a granular form to be added to food, pill form, chew tablets, and liquid suspensions. In one example, the composition may be formulated as animal feed, such as an extruded animal food, a grain, a canned food, an animal treat, a dog bone, an additive to fish food, a coating on animal forage, and the like.

Compositions containing nootkatone to treat or prevent tick infestations can be placed into the form of pharmaceutical dosage forms, such as solid oral forms such as tablets, capsules granules, pellets, or sachet, for example, or liquids such as solutions, suspensions, emulsions, elixirs, or capsules filled with the same, all for oral use, in the form of suppositories for rectal administration, or in the form of sterile injectable solutions for parenteral (including subcutaneous) use. Such pharmaceutical compositions and unit dosage forms thereof can comprise conventional ingredients in conventional proportions, with or without additional active compounds, and such unit dosage forms can contain any suitable effective amount of the active ingredient commensurate with the intended daily dosage range to be employed.

Compositions containing nootkatone to treat or prevent tick infestations can also contain one or more inactive pharmaceutical excipients such as diluents, lubricants, solubilizers, alcohols, binders, controlled release polymers, enteric polymers, disintegrants, colorants, flavorants, sweeteners, antioxidants, preservatives, pigments, additives, fillers, suspension agents, surfactants (for example, anionic, cationic, amphoteric and nonionic), and the like. Various FDA-approved inactive ingredients are found at the FDA's “The Inactive Ingredients Database” that contains inactive ingredients specifically intended as such by the manufacturer, whereby inactive ingredients can also be considered active ingredients under certain circumstances, according to the definition of an active ingredient given in 21 CFR 210.3(b)(7).

Compositions for ingestion can be administered hourly, daily, weekly, or monthly, as required. Compositions can be administered prophylactically, for example, when an individual is anticipated to be in an area where tick infestation is expected or when a change of season occurs where an increase in tick populations or different tick species is expected.

In certain embodiments, a composition dosage form can provide an amount of active ingredient (e.g., nootkatone) per dose to an individual in the range of about 5 mg to about 1000 mg, or in the range of about 5 mg to about 800 mg, or in the range of about 5 mg to about 500 mg, or in the range of about 5 mg to about 200 mg, or in the range of about 5 mg to about 100 mg, or in the range of about 5 mg to about 50 mg, or in the range of about 10 mg to about 1000 mg, or in the range of about 10 mg to about 800 mg, or in the range of about 10 mg to about 500 mg, or in the range of about 10 mg to about 200 mg, or in the range of about 10 mg to about 100 mg, or in the range of about 10 mg to about 50 mg.

In one embodiment, a composition may be applied directly to either a tick attempting to attach to an animal or an attached tick or may be applied indirectly to a tick by application to an area near the tick. For example, application may occur through transfer of the composition through emanation or some other means to the tick, or movement of the tick to the composition.

In other embodiments, a composition may be formulated for application to a hard surface, such as a structural surface, like untreated lumber, treated lumber, a wood beam, a wood board, cardboard, particle board, joist, stud and the like, a baseboard, wood trim, a hardwood floor, a window sill, a porch floor, a deck, a door, a wall, a ceiling, interior furniture, exterior furniture, and the like. Similarly, a composition may be formulated for application to a soft surface, such as a carpet, a curtain, a rug, padded furniture, a cushion, a mattress, a box spring, a mattress cover, a bedbug repellent mattress pad, a bed sheet, a blanket, a pillow, a doll, a stuffed animal, and the like.

In another embodiment, a composition may be formulated for application to an outdoor area, such as a lawn, a flower bed, a forest, a field, and the like. For example, the composition may be placed in a bug bomb, or a pressurized canister adapted to dispense the composition a distance of up to about 1 meter, or up to about 5 meters, or up to about 10 meters. In another example, the composition may be formulated for inclusion in a sprayer device to be connected to a water source and thereby dispensed over a large area.

In a further example, the composition may be formulated for reconstitution, such that it may be dispensed in a dry state, such as in a powder, grain, or mixture with other materials, such as animal forage, seed, or fertilizer. Once dispensed, the material may be reconstituted when combined with water.

In further embodiments, a composition contemplated herein may be sprayed, sprinkled, poured, or brushed onto a surface. In accordance, the composition may be formulated as a spray for a pump sprayer, a powder, a paint, a stain, a wax, a gel, a paste, or in any other form.

In further embodiments, a composition contemplated herein may be impregnated within a passive insect repellent dispenser and/or charged within a reservoir of an active insect repellent dispenser either of which may be wearable by an individual or that can be placed in an interior or exterior volume

In further embodiments, a composition contemplated herein may be impregnated within a carrier that is a device to be worn by an individual or an animal or as a woven or non-woven material. For example, the composition may be formulated as a bracelet, a necklace, a bandage or an article of clothing to be worn by an individual or an animal, such as a collar, harness, and the like. Examples of clothing contemplated include hats, gloves, pants, shirts, underwear, coats, bandanas, scarves, socks, shoes, shoelaces, footwear liners and inserts, gaiters, hunting clothes, military clothes, and the like.

Further, the composition may be formulated as part of a bandage, which further can include an antibiotic. The bandage may be configured with an adherent portion and a non-stick composition-carrying absorptive portion. Alternatively, the bandage may consist of a porous carrier portion that is adherent.

In another embodiment, the carry device may be a pet collar or other item to be worn by an animal.

Further, the composition may be formulated as a blanket, a netting, an insect trap, such as or similar to fly paper, a glue trap, a colored trap, and the like.

In another embodiment, a device including an attractant may be used to carry a contemplated composition. For example, the device may include an insect or pest food and/or a pheromone and/or a scent and/or a lure and/or may emit light and/or sound including subsonic emissions, and the like.

In one embodiment, compositions contemplated herein may be applied to one or more surfaces using an applicator having a reservoir for carrying the composition in a wet form or a dry form. Examples of applicators that may be used include an aerosol container with a spray nozzle with or without a spray straw to focus delivery of the composition, a spray gun, an impregnated sheet, film, and/or matrix where the composition is released onto the surface by a releasing agent, such as water or other carrier. Additional examples include a roll-on dispenser, such as is used for liquid deodorant application, a telescopic gel/wax dispenser, similar to a gel deodorant applicator, lip balm dispenser, or a glue stick, a squeeze tube, a pen, such as is used for a bleach pen or an anti-itch composition applicator, a felt-tip marker, a temporary tattoo, a stamp such as a self-inking stamp, a pump sprayer, a trigger sprayer, a pressurized spraying device, a sponge, a squeegee, an airbrush, a brush, a roller, a powder dispenser, such as for dispensing foot powder, a hair brush that dispenses composition into the bristles when the brush used on hair, a comb that dispenses composition onto the teeth when the comb is used on hair.

The invention will be further described in the following examples, which do not limit the scope of the invention described in the claims.

### EXAMPLES

The Examples that follow are illustrative of specific embodiments of the invention, and various uses thereof. They are set forth for explanatory purposes only and are not taken as limiting the invention.

### Example No. 1: Development of Nootkatone Formulations

### Overview

Nootkatone (obtained from oxidation of fermentation-derived valencene, “nootkatone ex valencene” or “NxV” with >98% purity) formulations for topical application were developed to determine whether such nootkatone and formulations thereof can repel and/or kill ticks on an animal's skin. Further, derivatives of nootkatone ex valencene were also tested for repellent activity.

### Experimental Design

Laboratory testing on ticks established that 2% nootkatone nootkatone ex citrus) can repel and kill ticks. Therefore, new formulations with working concentrations of 2% nootkatone were sought. Specifically, a nootkatone-containing spray, nootkatone-containing lotion, and a nootkatone-containing soap were developed. Separately, derivatives of the nootkatone used herein, namely 1,10-dihydronootkatone, 11,12-dihydronootkatone, and tertrahydronootkatone were evaluated for biocidal activity.

Initially, solvent dissolution tests of nootkatone were performed. Of the solvents tested, only water and glycerin were unable to successfully dissolve nootkatone (data not shown).

Space Spray Formulations

Next, space spray formulations were developed. Initial formulations were evaluated as shown in Table No. 2.

TABLE NO. 2
Space Spray Formulation Evaluation

| | 1 (wt. %) | 2 (wt. %) | 3 (wt. %) | 4 (wt. %) | 5 (wt. %) | 6 (wt. %) | 7 (wt. %) | 8 (wt. %) | Order |
|---|---|---|---|---|---|---|---|---|---|
| Ingredient | | | | | | | | | |
| Nootkatone | 2.0 | 2.0 | 2.0 | 2.0 | 2.0 | 2.0 | 2.0 | 2.0 | 2 |
| Drakeol 7 | 10.0 | 88.0 | 30.0 | 30.0 | 20.0 | 20.0 | 20.0 | 20.0 | 1 |
| IPA | 88.0 | 10.0 | | | | | | | 3 |
| Aerosol OT S | | | | | 1.0 | | 2.0 | | 4 |
| Rhodacal CA | | | | | | 1.0 | | 2.0 | 4 |
| Tween 80 | | | 3.0 | | 3.0 | 3.0 | 5.0 | 5.0 | 4 |
| Alkamuls EL 719 | | | | 3.0 | | | | | 4 |
| Water | | | 65.0 | 65.0 | 74.0 | 74.0 | 71.0 | 71.0 | 5 |
| Appearance | Clear | Clear | White | White | White | White | White | White | Combine |
| | colorless | colorless | opaque | opaque | opaque | opaque | opaque | opaque | ingredients |
| | solution, | solution, | emulsion, | emulsion, | emulsion, | emulsion, | emulsion, | emulsion, | #1 4 with |
| | no | no | 50% | 50% | 50% | 50% | 25% | 10% | stirring then |
| | separation | separation | separation | separation | separation | separation | separation | separation | add to water |
| | | | after 1 | after 1 | after 1 | after 1 | after 1 | after 1 | with hi shear |
| | | | hour | hour | hour | hour | hour | hour | mixing |
| Particle size (μm) | | | | | | | | | |
| 10%< | Solution | Solution | 5.87 | 4.74 | 4.27 | 3.91 | 3.67 | 1.99 | |
| 50%< | | | 9.57 | 7.69 | 6.75 | 6.87 | 5.94 | 4.71 | |
| 80%< | | | 13.05 | 10.54 | 9.19 | 10.09 | 8.33 | 7.35 | |
| 90%< | | | 15.20 | 12.30 | 10.73 | 12.19 | 9.91 | 9.04 | |
| 99%< | | | 20.86 | 16.91 | 14.83 | 17.73 | 14.40 | 13.25 | |

Solvent-based nootkatone formulation sprays were successful with no separation or crystallization. Water-based formulations, however, separated rapidly and were not used.

Next, solvents were tried with the same emulsifiers as the best formulation with the slowest separation and smallest particle size from Table No. 2. Formulations were evaluated on appearance, suspensibility, and particle size. Two additional formulations containing only emulsifiers, nootkatone, and water were also prepared, as shown in Table No. 3.

TABLE NO. 3
Space Spray Formulation Evaluation

| | 1 (wt [symbol] | 2 (wt. %) | 3 (wt. %) | 4 (wt. %) | 5 (wt. %) | 6 (wt. %) | Order |
|---|---|---|---|---|---|---|---|
| Ingredient | | | | | | | |
| Nootkatone | 2 | 2 | 2 | 2 | 2 | 2 | 2 |
| Butyl lactate | 20 | | | — | | | 1 |
| Citroflex A4 | | 20 | | — | | | 1 |
| Finsolv TN | | | 20 | — | | | 1 |
| Benzyl Alcohol | | | | 20 | | | 1 |
| Rhodacal CA | 2 | 2 | 2 | 2 | 2 | 2 | 3 |
| Tween 80 | 5 | 5 | 5 | 5 | 20 | | 4 |
| Alkamuls EL 719 | | | | — | | 20 | 4 |
| Water | 71 | 71 | 71 | 71 | 76 | 76 | 5 |
| Appearance | translucent | opaque | Opaque | Opaque | Clear pale | Clear | Combine |
| | pale amber | white | white | white | amber | amber | ingredients 1 4 with |
| | oil | emulsion, | emulsion, | emulsion, | solution, | solution, | mixing, then add |
| | separated | 5% top | no | no | no | no | to water with hi |
| | to top | separation | separation | separation | separation | separation | shear mixing |
| Particle size (μm) | | | | | | | |
| 10%< | Separated | 3.97 | 0.09 | 0.15 | Solution, | Solution, | |
| 50%< | | 6.51 | 0.35 | 0.53 | no | no | |
| 80%< | | 9.02 | 3.13 | 1.03 | separation | separation | |
| 90%< | | 10.59 | 4.92 | 1.30 | at any | at any | |
| 99%< | | 14.64 | 9.26 | 1.88 | dilution | dilution | |
| | | | | | rate | rate | |

For the solvent-based formulations, formula #1 from Table No. 2 with increased IPA was preferred for its less oily feel and faster evaporation. For the water-based formulations, formula #4 from Table No. 3 was preferred for its suspensibility, particle size, and coating ability. Alternative formulations in Table No. 3 are formula #3 with Finsolv TN solvent and #5 & #6 with Tween 80 or Alkamuls EL-719 and water.

Glycerin Hand Soap

Nootkatone hand soap was developed with a combination of surfactants, emulsifiers, and glycerin, as shown in Table No. 4.

TABLE No. 4
Glycerin Hand Soap Formula Evaluation

| Ingredients | Chemical Type | 1 (wt. %) | 2 (wt. %) | 3 (wt. %) | Order |
|---|---|---|---|---|---|
| Nootkatone | Active | 2.0 | 2.0 | 2.0 | 2 |
| Glycerin | Humectant | 5.0 | 5.0 | 5.0 | 6 |
| Sodium chloride | Thickener | 1.0 | 1.0 | 1.0 | 7 |
| Steol CS 330 | Sodium Laureth Sulfate | 15.0 | | 20.0 | 1 |
| Jarfactant 425N | Decyl Glucoside | | 15.0 | | 1 |
| Amphosol CA | Cocamidopropyl betaine | 5.0 | 5.0 | 10.0 | 5 |
| Stepanol WA Extra | Sodium Lauryl Sulfate | 10.0 | 10.0 | | 4 |
| Water | Solvent | 62.0 | 62.0 | 62.0 | 3 |

| | | | |
|---|---|---|---|
| Appearance | opaque off | opaque off | translucent |
| | white | white | pale yellow |
| | viscous | viscous | viscous |
| | liquid, | liquid, | liquid, no |
| | flocculation | bottom | separation |
| | separation | clearing | |
| | | separation | |
| pH (of Concentrate): | 7.62 | 7.45 | 6.92 |

Formula #3 without Stepanol WA-extra was preferred with no separation or flocculation and a neutral pH.

Development of Cream Formula

Nootkatone hand cream (lotion) was developed (formulations 1 and 2) with a combination of solvents, surfactants, waxes, and humectant, as shown in Table No. 5.

TABLE No. 5
Cream Formula Evaluation

| | |
|---|---|
| 1 | 2 |

| Ingredients | (wt. %) | Order | (wt. %) | Order |
|---|---|---|---|---|
| Nootkatone | 2.0 | A3 | 2.0 | A2 |
| IPM | 5.0 | A1 | | |
| Mineral oil | 15.0 | A2 | 10.0 | A1 |
| Lexamine 22 | 3.0 | A4 | | |
| IPA | 5.0 | A5 | | |
| Natrosol 250HHR CS | 1.5 | C2 | | |
| Germaben II | 1.0 | C1 | 1.0 | C1 |
| Polawax | | | 4.0 | A3 |
| Ritalan | | | 2.0 | A4 |
| Volpo S 2 | | | 1.0 | A5 |
| Volpo s 20 | | | 2.0 | A6 |
| Carbopol 934 | | | 0.25 | B2 |
| Triethanolamine | | | 0.4 | C2 |
| Glycerin | | | 5.0 | B3 |
| Water | 67.5 | B1 | 72.35 | B1 |

| | | |
|---|---|---|
| Appearance: | Amber opaque | Opaque white |
| | cream, | thick cream, no |
| | separated oil | separation |
| | layer on top | |

Order of addition:

1) Ingredients A were combined and heated to −70° C. to melt waxes.

2) Ingredients B were combined and heated to −70° C.

3) Mixture A was poured into B while hot and allowed to cool to −40° C.

4) Ingredients C were added and allowed to stir until cooled.

Formula #2 was preferred as it formed a thick opaque white cream with no separation.

Chemical Synthesis of Nootkatone Derivatives

Derivatives of nootkatone ex valencene were synthesized as follows.

First, 11,12-dihydronootkatone was synthesized by hydrogenation of nootkatone in benzene using Wilkinson's reagent (2.5 g; 5% weight of nootkatone), at 7 bar pressure over time period of 2 hours. The product was purified by distillation and analyzed by GC, GC-MS and ¹H NMR to confirm chemical identity.

Next, 1,10-dihydronootkatone was synthesized by biphasic reaction between nootkatone and Aliquat 336 in toluene and NaHCO₃ and Na₂SO₄ in water. The reaction was run for 2 hours at 65° C. for 2 hours. The product was purified by distillation and analyzed by GC, GC-MS and ¹H NMR to confirm chemical identity.

Finally, tetrahydronootkatone was synthesized by hydrogenation of nootkatone in ethanol using 10% Pd on carbon catalyst (dry basis, 2.5 g for 50 g nootkatone typically), at 30-55 psi hydrogen in a pressure reactor, with cooling for temperature control (typically 15-20° C.). Reactions typically were run for 5 hours or more. The product was purified using distillation.

### Example No. 2: Determination of Repellent Activity

### Overview

The repellent activity of the preferred space spray, soap, and cream were evaluated from Example No. 1 using a human finger assay. Further, a shell-vial assay was performed on the preferred space spray, soap, and cream along with the nootkatone derivatives.

### Experimental Design

Human Finger Trial

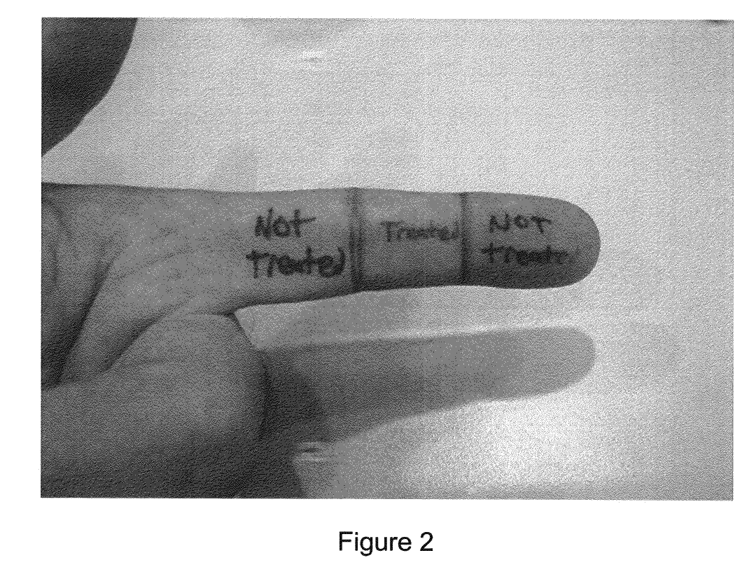

A human index finger was divided into three zones, as shown in FIG. 2, including a formula treated zone in the center surrounded by untreated zones.

Ten nymphal ticks were introduced to the untreated-introduction zone (tip of the index finger). Once the ticks are introduced, the assay was run for 5 minutes with the finger held vertically (ticks quest against gravity). The percent repellency was determined by #/10 that did not cross the treated zone. Products were tested at 10 min, 1, & 2 hr post-treatment along with blank controls, which were the same formulations without nootkatone. Ten ticks tested at each time point for 5 minutes (total of 3 reps). The results are shown in Table No. 6.

TABLE No. 6
Finger assay with Soap, Lotion (cream), and Space Spray

# Ticks Repelled/# Ticks Tested

| Test Product | 10 min | 1 hr | 2 hr | 3 hr |
|---|---|---|---|---|
| 2% Nootkatone | 5/10 | 0/10 | | |
| Soap | | | | |
| 2% Nootkatone | 6/10 | 0/10 | | |
| Soap | | | | |
| 2% Nootkatone | 4/10 | 1/10 | | |
| Soap | | | | |
| 2% Nootkatone | 8/10 | 2/10 | 0/10 | |
| Soap | | | | |
| % Repelled | 23/40 | 3/40 | 0/10 | |
| | (57.5%) | (7.5%) | (0%) | |
| Soap Control | 1/10 | 0/10 | 0/10 | |
| Soap Control | 1/10 | 1/10 | 0/10 | |
| % Repelled | 2/20 | 1/20 | 0/20 | |
| | (10%) | (5%) | (0%) | |
| 2% Nootkatone | 9/10 | 5/10 | | |
| Lotion | | | | |
| 2% Nootkatone | 10/10 | 6/10 | | |
| Lotion | | | | |
| 2% Nootkatone | 9/10 | 1/10 | 0/10 | |
| Lotion | | | | |
| 2% Nootkatone | 10/10 | 1/10 | 1/10 | |
| Lotion | | | | |
| 2% Nootkatone | 10/10 | 3/10 | 0/10 | |
| Lotion | | | | |
| % Repelled | 48/50 | 16/50 | 1/30 | |
| | (96%) | (32%) | (3%) | |
| Lotion Control | 0/10 | 0/10 | 0/10 | |
| Lotion Control | 0/10 | 0/10 | 0/10 | |
| Lotion Control | 0/10 | 0/10 | 0/10 | |
| % Repelled | 0/30 | 0/30 | 0/30 | |
| | (0%) | (0%) | (0%) | |
| 2% Nootkatone | 10/10 | 8/10 | 0/10 | |
| Spray | | | | |
| 2% Nootkatone | 10/10 | 7/10 | 1/10 | |
| Spray | | | | |
| 2% Nootkatone | 10/10 | 6/10 | 5/10 | 5/10 |
| Spray | | | | |
| 2% Nootkatone | 10/10 | 7/10 | 5/10 | 6/10 |
| Spray | | | | |
| 2% Nootkatone | 10/10 | 8/10 | 6/10 | 4/10 |
| Spray | | | | |
| % Repelled | 50/50 | 36/50 | 17/50 | 15/30 |
| | (100%) | (72%) | (34%) | (50%) |
| Spray Control | 10/10 | 0/10 | 0/10 | 0/10 |
| Spray Control | 10/10 | 0/10 | 0/10 | 0/10 |
| Spray Control | 10/10 | 0/10 | 0/10 | 0/10 |
| % Repelled | 30/30 | 0/30 | 0/30 | 0/30 |
| | (100%) | (0%) | (0%) | (0%) |

Compared to a 2% nootkatone in ethanol composition (66 μL of 2% solution applied to achieve 4 μL/cm² surface concentration), which achieved greater than 90% repellency through 4 hours (data not shown), the nootkatone-containing soap, lotion, and spray formulations did not perform well.

To determine whether each nootkatone-containing soap, lotion, and spray formulation contained the requisite amount of nootkatone (final concentration of 2%), a GC/MS assay was performed. Each formulation was determined to have an adequate amount of nootkatone (at least %1.76 nootkatone).

Shell-Vial Bioassay

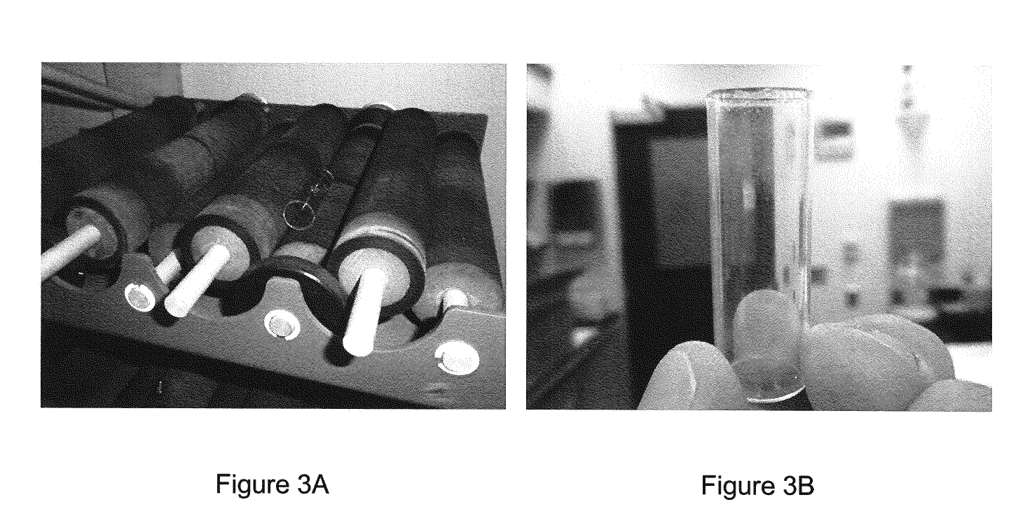

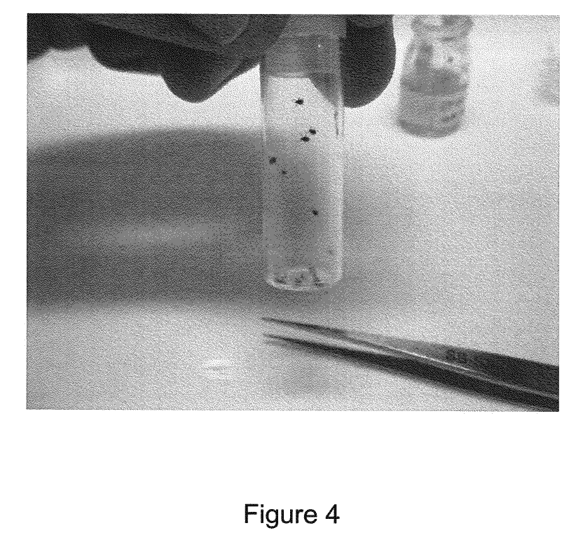

Next, a shell-vial bioassay was performed to determine whether the nootkatone of the test products (i.e., space spray, lotion, and soap) lost biocidal activity due to the formulation process. The nootkatone derivatives from Example No. 1 were also tested to determine relative biocidal activity. Serial dilutions of each 2% product and nootkatone derivatives were made for a total of 8 concentrations per formulation/derivative. Controls included untreated controls and a nootkatone in acetone composition as a positive control. One hundred and fifty microliters of each concentration was added to a 1 dram glass shell vial and allowed to dry (see FIGS. 3A and 3B).

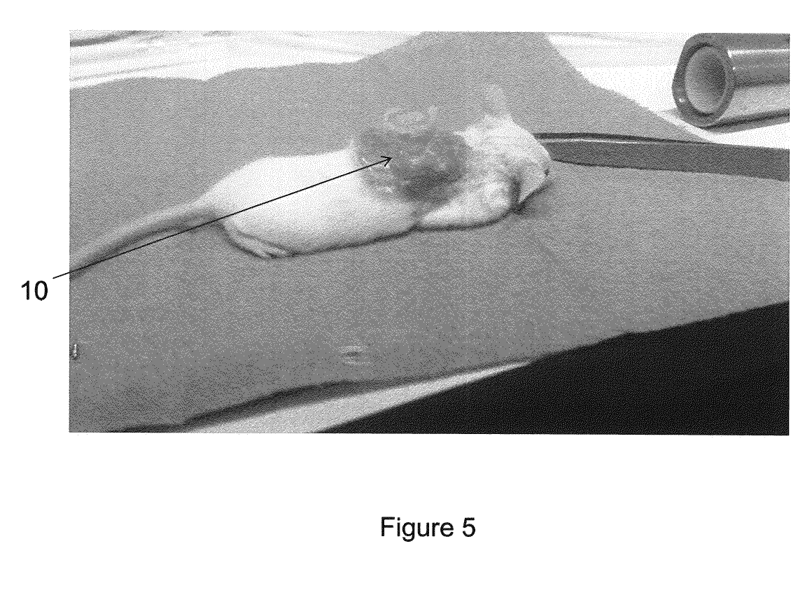

Ten ticks were added per shell vial per concentration per formulation/derivative and a lid applied with holes for air exchange, as seen in FIG. 4. Each shell vial with ticks added was placed in a humid container, and morbidity and mortality of ticks were determined at 1 hr and 24 hr post-treatment. Each experiment was performed twice and the results averaged. Results are shown in Table No. 7.

TABLE NO. 7
Shell-vial bioassay for Soap, Lotion (cream), and
Space Spray Formulations and Nootkatone Derivatives

| | Nootkatone # Alive/10 | | | | | | | | | |
|---|---|---|---|---|---|---|---|---|---|---|
| Time | 0.5% | 0.25% | 0.13% | 0.06% | 0.03% | 0.02% | 0.01% | 0.00% | 0.00% | con |
| 1 hr | 1 | 2 | 4 | 4 | 4 | 5 | 5 | 6 | 8 | 10 |
| 24 hr | 0 | 0 | 0 | 0 | 0 | 0 | 7 | 10 | 10 | 10 |
| 1 hr | 3 | 3 | 4 | 4 | 4 | 5 | 7 | 9 | 9 | 10 |
| 24 hr | 0 | 0 | 0 | 0 | 0 | 0 | 5 | 9 | 9 | 10 |
| | 1,10 dihydronootkatone # Alive/10 | | | | | | | | | |
| Time | 0.5% | 0.25% | 0.125% | 0.063% | 0.031% | 0.016% | 0.008% | 0.004% | 0.002% | con |
| 1 hr | / | 10 | 10 | 10 | 10 | 10 | 10 | 10 | 10 | 10 |
| 24 hr | / | 1 | 2 | 1 | 3 | 6 | 6 | 10 | 9 | 9 |
| | 11,12 dihydronootkatone # Alive/10 | | | | | | | | | |
| Time | 0.5% | 0.25% | 0.125% | 0.063% | 0.031% | 0.016% | 0.008% | 0.004% | 0.002% | con |
| 1 hr | / | 2 | 2 | 10 | 10 | 10 | 10 | 10 | 10 | 10 |
| 24 hr | / | 0 | 0 | 0 | 0 | 0 | 1 | 7 | 6 | 10 |

| | Tetrahydronootkatone # Alive/10 | | | | | | | | | |
|---|---|---|---|---|---|---|---|---|---|---|
| Time | 0.5% | 0.25% | 0.125% | 0.063% | 0.031% | 0.016% | 0.008% | 0.004% | 0.002% | con |
| 1 hr | / | 5 | 6 | 6 | 7 | 7 | 9 | 10 | 10 | 10 |
| 24 hr | / | 1 | 4 | 5 | 7 | 7 | 9 | 10 | 10 | 10 |
| #alive/10 | | 0.25% | 0.125% | 0.062% | 0.032% | 0.016% | 0.008% | 0.004% | 0.002% | con |
| Spray | 1 hr | 0 | 0 | 0 | 1 | 2 | 0 | 0 | 0 | 10 |
| | 24 hr | 0 | 0 | 0 | 2 | 0 | 0 | 0 | 0 | 10 |
| Soap | 1 hr | 0 | 0 | 0 | 0 | 5 | 4 | 6 | 8 | 10 |
| | 24 hr | 0 | 0 | 0 | 0 | 0 | 4 | 6 | 7 | 10 |
| Lotion | 1 hr | 0 | 0 | 0 | 9 | 7 | 9 | 10 | 10 | 10 |
| | 24 hr | 0 | 0 | 0 | 0 | 0 | 3 | 7 | 8 | 10 |

LC50 values for nootkatone only controls and the nootkatone derivatives were calculated at 24 hours from the results shown in Table No. 7 and are shown in Table No. 8.

TABLE No. 8
LC50 values for Nootkatone Derivatives

| Sample | LC50 |
|---|---|
| Nootkatone control | 0.0074% |
| Nootkatone control | 0.0073% |
| 1,10 | 0.0097% |
| dihydronootkatone | |
| 11,12 | 0.0071% |
| dihydronootkatone | |
| tetrahydronootkatone | 0.0780% |

The results shown in Table No. 7 demonstrate that the nootkatone within the formulations retained its biocidal activity. Moreover, the results in Table Nos. 7 and 8 indicate that chemical derivatives of nootkatone ex valencene can be as effective against ticks as nootkatone.

### Example No. 3: Reformulation and Testing of Nootkatone-Containing Compositions Formulations

### Overview

Though the nootkatone within space spray, soap, and lotion formulations from Example No. 1 retained its biocidal activity, the formulation process apparently sequestered the nootkatone somehow rendering the formulations less effective than desired. Therefore, new formulations were made to overcome this obstacle.

### Experimental Design

Here, new formulations that overcame the nootkatone sequestering effect were sought. Specifically, a nootkatone-containing spray and nootkatone-containing lotion were developed. The new formulations are listed in Table No. 9.

TABLE No. 9
Reformulated Nootkatone-containing Compositions

| | ECS- | ECS- | ECS- | ECS- | ECS- |
|---|---|---|---|---|---|
| | F-298 | F-299 | F-300 | F-301 | F-302 |
| Ingredients | (Lotion) | (Lotion) | (Spray) | (Spray) | (Spray) |
| Nootkatone | 2.0% | 2.0% | 2.0% | 2.0% | 2.0% |
| Aerosol OT-B | — | — | 0.2% | 0.2% | — |
| Tween 80 | — | 3.0% | — | — | — |
| IPM | — | 5.0% | — | — | — |
| Natrosol 250HR | — | 3.0% | — | — | — |
| Atlox G-5000 | — | — | 2.0% | — | — |
| Atlox | — | — | — | 2.0% | — |
| Metasperse | | | | | |
| 550S-LQ | | | | | |
| BHT | — | — | — | — | 0.1% |
| Volpo S-2 | 1.0% | — | — | — | — |
| Volpo S-20 | 2.0% | — | — | — | — |
| Polawax | 4.0% | — | — | — | — |
| Carbapol 934 | 2.0% | — | — | — | — |
| Triethanolamine | 0.4% | — | — | — | — |
| Water | 88.6% | 87.0% | 95.8% | 95.8% | — |
| IPA | — | — | — | — | 97.9% |

Human Finger Trial

As described above, a human finger trial was performed with the new formulations. Products were tested at 10 min, 1, 2, and 3 hr post-treatment along with blank controls, which replaced nootkatone with more carrier (i.e., water or isopropyl alcohol). Ten ticks tested at each time point for 5 minutes (total of 3 reps). The results are shown in Table No. 10.

TABLE NO. 10
Finger assay with Reformulated Lotions and Space Sprays

| Test Product | Trial # | 10 min | | 1 hr | | 2 hr | | 3 hr | | | |
|---|---|---|---|---|---|---|---|---|---|---|---|
| ECS-F-298 | 1 | 8/10 | (80%) | 10/10 | (100%) | 9/10 | (90%) | 7/10 | (70%) | | |
| (lotion) | 2 | 10/10 | (100%) | 5/10 | (50%) | 9/10 | (90%) | 8/10 | (80%) | | |
| | 3 | 10/10 | (100%) | 9/10 | (90%) | 8/10 | (80%) | 8/10 | (80%) | | |
| | Mean | 28/30 | (93.3%) | 24/30 | (80%) | 26/30 | (86.7%) | 23/30 | (76.7%) | 101/120 | (84.2%) |
| ECS-F-298 | 1 | 5/10 | (50%) | 0/10 | (0%) | 0/10 | (0%) | 0/10 | (0%) | | |
| blank | 2 | 1/10 | (10%) | 0/10 | (0%) | 1/10 | (10%) | 0/10 | (0%) | | |
| | 3 | 0/10 | (0%) | 0/10 | (0%) | 0/10 | (0%) | 0/10 | (0%) | | |
| | Mean | 6/30 | (20%) | 0/30 | (0%) | 1/30 | (3.3%) | 0/30 | (0%) | 7/120 | (5.8%) |
| ECS -F-299 | 1 | 10/10 | (100%) | 7/10 | (70%) | 7/10 | (70%) | 8/10 | (80%) | | |
| (lotion) | 2 | 10/10 | (100%) | 7/10 | (70%) | 8/10 | (80%) | 7/10 | (70%) | | |
| | 3 | 5/10 | (50%) | 6/10 | (60%) | 6/10 | (60%) | 3/10 | (30%) | | |
| | Mean | 25/30 | (83.3%) | 20/30 | (66.7%) | 21/30 | (70%) | 18/30 | (60%) | 84/120 | (70%) |
| ECS-F-299 | 1 | 0/10 | (0%) | 0/10 | (0%) | 1/10 | (10%) | 0/10 | (0%) | | |
| blank | 2 | 1/10 | (10%) | 0/10 | (0%) | 0/10 | (0%) | 0/10 | (0%) | | |
| | 3 | 0/10 | (0%) | 0/10 | (0%) | 0/10 | (0%) | 0/10 | (0%) | | |
| | Mean | 1/30 | (3.3%) | 0/30 | (0%) | 1/30 | (3.3%) | 0/30 | (0%) | 2/120 | (1.7%) |
| ECS-F-301 | 1 | 10/10 | (100%) | 9/10 | (90%) | 6/10 | (60%) | 3/10 | (30%) | | |
| (lotion) | 2 | 9/10 | (90%) | 8/10 | (80%) | 5/10 | (50%) | 7/10 | (70%) | | |
| | 3 | 10/10 | (100%) | 8/10 | (80%) | 8/10 | (80%) | 8/10 | (80%) | | |
| | Mean | 29/30 | (96.7%) | 25/30 | (83.3%) | 19/30 | (63.3%) | 18/30 | (60%) | 91/120 | (75.8%) |
| ECS-F-301 | 1 | 0/10 | (0%) | 1/10 | (10%) | 0/10 | (0%) | 0/10 | (0%) | | |
| blank | 2 | 0/10 | (0%) | 0/10 | (0%) | 0/10 | (0%) | 0/10 | (0%) | | |
| | 3 | 0/10 | (0%) | 0/10 | (0%) | 1/10 | (10%) | 0/10 | (0%) | | |
| | Mean | 0/30 | (0%) | 1/30 | (3.3%) | 1/30 | (3.3%) | 0/30 | (0%) | 2/120 | (1.7%) |
| ECS-F-300 | 1 | 10/10 | (100%) | 10/10 | (100%) | 10/10 | (100%) | 9/10 | (90%) | | |
| (spray) | 2 | 10/10 | (100%) | 8/10 | (80%) | 7/10 | (70%) | 2/10 | (80%) | | |
| | 3 | 10/10 | (100%) | 0/10 | (0%) | 8/10 | 80%) | 4/10 | (40%) | | |
| | Mean | 30/30 | (100%) | 18/30 | (60%) | 25/30 | (83.3%) | 15/30 | (50%) | 88/120 | (73.3%) |
| ECS-F-300 | 1 | 0/10 | (0%) | 0/10 | (0%) | 0/10 | (0%) | 0/10 | (0%) | | |
| blank | 2 | 1/10 | (10%) | 1/10 | (10%) | 0/10 | (0%) | 0/10 | (0%) | | |
| | 3 | 1/10 | (10%) | 0/10 | 0%) | 1/10 | (10%) | 0/10 | (0%) | | |
| | Mean | 2/30 | (6.7%) | 1/30 | (3.3%) | 1/30 | (3.3%) | 0/30 | (0%) | 4/120 | (3.3%) |
| ECS-F-302 | 1 | 10/10 | (100%) | 10/10 | (100%) | 10/10 | (100%) | 8/10 | (80%) | | |
| (spray) | 2 | 10/10 | (100%) | 10/10 | (100%) | 10/10 | (100%) | 9/10 | (90%) | | |
| | 3 | 10/10 | (100%) | 10/10 | (100%) | 8/10 | (80%) | 5/10 | (50%) | | |
| | Mean | 30/30 | (100%) | 30/30 | (100%) | 28/30 | (93.3%) | 22/30 | (73.3%) | 110/120 | (91.7%) |
| ECS-F-302 | 1 | 0/10 | (0%) | 1/10 | (10%) | 1/10 | (10%) | 0/10 | (0%) | | |
| blank | 2 | 0/10 | (0%) | 0/10 | (0%) | 0/10 | (0%) | 1/10 | (10%) | | |
| | 3 | 1/10 | (10%) | 0/10 | (0%) | 0/10 | (0%) | 0/10 | (0%) | | |
| | Mean | 1/30 | (3.3%) | 1/30 | (3.3%) | 1/30 | (3.3%) | 1/30 | (3.3%) | 4/120 | (3.3%) |

The results shown in Table No. 10 demonstrate that the reformulated nootkatone compositions exhibited good biocidal activity and therefore solved the nootkatone sequestration problem.

Shell-Vial Bioassay

To confirm the Human Finger assay results, a shell-vial bioassay was performed as described above on the formulations of Table No. 9 with the exception that morbidity and mortality of ticks was only determined at 24 hr post-treatment. Each experiment was performed three times and the results averaged. The results are shown in Table No. 11.

TABLE NO. 11
Shell-vial bioassay for Reformulated Lotion (cream) and Space Spray Formulations

| Time | 0.5% | 0.25% | 0.125% | 0.062% | 0.031% | 0.013% | 0.008% | 0.004% | 0.002% | con |
|---|---|---|---|---|---|---|---|---|---|---|
| | ECS-F-298 # Alive/10 | | | | | | | | | |
| 24 hr | 0 | 0 | 0.33 | 4.67 | 5.33 | 7.67 | 9.67 | 10 | 10 | 10 |
| | ECS-F-299 # Alive/10 | | | | | | | | | |
| 24 hr | 0.33 | 0 | 1.67 | 2.67 | 7.00 | 7.67 | 9.33 | 9.67 | 10 | 10 |
| Time | 0.5% | 0.25% | 0.125% | 0.063% | 0.031% | 0.016% | 0.008% | 0.004% | 0.002% | con |
| | ECS-F-300 # Alive/10 | | | | | | | | | |
| 24 hr | 1.33 | 4.33 | 5.67 | 7.67 | 9.67 | 10 | 10 | 10 | 10 | 10 |
| | ECS-F-301 # Alive/10 | | | | | | | | | |
| 24 hr | 0.67 | 4.0 | 3.67 | 8.0 | 9.33 | 9.67 | 8.33 | 10 | 9.67 | 10 |
| | ECS-F-302 # Alive/10 | | | | | | | | | |
| 24 hr | 1 | 1.33 | 3.67 | 4.67 | 6.67 | 8.67 | 9.67 | 9.67 | 9.67 | 10 |

LC50 values for the nootkatone formulations were calculated from the results shown in Table No. 11 and are shown in Table No. 12.

TABLE No. 12
LC50 values for Reformulated Nootkatone Compositions

| Sample | LC50 |
|---|---|
| ECS-F-298 | 0.019% |
| ECS-F-299 | 0.02% |
| ECS-F-300 | 0.085% |
| ECS-F-301 | 0.061% |
| ECS-F-302 | 0.033% |

### Example No. 4: Additional Formulation and Testing of Nootkatone-containing Compositions

### Overview

Due to the successful reformulation effort of Example No. 3 and the results (see above) that even lower percentages of nootkatone (i.e., nootkatone ex citrus) can kill ticks, additional nootkatone-containing formulations with different nootkatone concentrations were developed.

### Experimental Design

Here, new formulations that overcame the nootkatone sequestering effect were sought. Specifically, a nootkatone-containing spray and nootkatone-containing lotion were developed. The new formulations are listed in Table No. 13 and 14.

TABLE No. 13
Varied Concentration Nootkatone-containing Lotions

| | ECS-F-335 | ECS-F-336 | ECS-F-338 | ECS-F-339 |
|---|---|---|---|---|
| Ingredients | (Lotion) | (Lotion) | (Lotion) | (Lotion) |
| Nootkatone | 1.0% | 0.5% | 1.0% | 0.5% |
| Volpo S-2 | 1.0% | 1.0% | 1.0% | 1.0% |
| Volpo S-20 | 2.0% | 2.0% | 2.0% | 2.0% |
| Polawax | 4.0% | 4.0% | 4.0% | 4.0% |
| Carbapol 934 | 2.0% | 2.0% | 2.0% | 2.0% |
| Triethanol- | 0.4% | 0.4% | 0.4% | 0.4% |
| amine | | | | |
| Mineral Oil | — | — | 10.0% | 10.0% |
| Water | 89.6% | 90.1% | 79.6% | 80.1% |

TABLE No. 14
Varied Concentration Nootkatone-containing Sprays

| | ECS-F-341 | ECS-F-342 |
|---|---|---|
| Ingredients | (Spray) | (Spray) |
| Nootkatone | 1.0% | 0.5% |
| BHT | 0.1% | 0.1% |
| IPA | 98.9% | 99.4% |

Human Finger Trial

As described above, a human finger trial was performed with the new formulations of Example No. 4. Products were tested at 10 min, 1, 2, and 3 hr post-treatment along with blank controls, which replaced nootkatone with more carrier (i.e., water or isopropyl alcohol). Ten ticks tested at each time point for 5 minutes (total of 3 reps). The results are shown in Table No. 15.

TABLE NO. 15
Finger assay with Reformulated Lotions and Space Sprays

| Test Product | Trial # | 10 min | 1 hr | 2 hr | 3 hr |
|---|---|---|---|---|---|
| ECS-F-335 | 1 | 10/10 (100%) | 9/10 (90%) | 9/10 (90%) | 7/10 (70%) |
| (1% lotion) | | | | | |
| | 2 | 10/10 (100%) | 9/10 (90%) | 8/10 (80%) | 9/10 (90%) |
| | 3 | 9/10 (90%) | 7/10 (70%) | 4/10 (40%) | 0/10 (0%) |
| | Mean | 97% | 83% | 70.00% | 53% |
| ECS-F-336 | 1 | 10/10 (100%) | 8/10 (80%) | 4/10 (40%) | 5/10 (50%) |
| (0.5% lotion) | | | | | |
| | 2 | 9/10 (90%) | 8/10 (80%) | 3/10 (30%) | 0/10 (0%) |
| | 3 | 1/10 (10%) | 3/10 (30%) | 0/10 (0%) | 1/10 (10%) |
| | Mean | 67% | 63% | 23% | 20% |
| ECS-F-337 | 1 | 7/10 (70%) | 3/10 (30%) | 1/10 (10%) | 0/10 (0%) |
| (blank lotion | | | | | |
| for ECS-F-336) | | | | | |
| | 2 | 1/10 (10%) | 0/10 (0%) | 0/10 (0%) | 0/10 (0%) |
| | 3 | 2/10 (20%) | 0/10 (0%) | 0/10 (10%) | 0/10 (10%) |
| | Mean | 33% | 10% | 3% | 0% |
| ECS-F-338 | 1 | 10/10 (100%) | 8/10 (80%) | 1/10 (10%) | 1/10 (10%) |
| (1% lotion + oil) | | | | | |
| | 2 | 10/10 (100%) | 5/10 (50%) | 3/10 (30%) | 1/10 (10%) |
| | 3 | 10/10 (100%) | 7/10 (70%) | 4/10 (40%) | 1/10 (10%) |
| | Mean | 100% | 67% | 27% | 10% |
| ECS-F-339 | 1 | 8/10 (80%) | 6/10 (60%) | 0/10 (0%) | 0/10 (0%) |
| (0.5% lotion + oil) | | | | | |
| | 2 | 8/10 (80%) | 5/10 (50%) | 0/10 (0%) | 0/10 (0%) |
| | 3 | 7/10 (70%) | 4/10 (40%) | 1/10 (10%) | 0/10 (0%) |
| | Mean | 77% | 50% | 3% | 0% |
| ECS-F-340 | 1 | 5/10 (50%) | 0/10 (0%) | 0/10 (0%) | 0/10 (0%) |
| (blank lotion | | | | | |
| for ECS-F-339) | | | | | |
| | 2 | 2/10 (20%) | 0/10 (0%) | 1/10 (10%) | 0/10 (0%) |
| | 3 | 3/10 (30%) | 1/10 (10%) | 0/10 (0%) | 0/10 (0%) |
| | Mean | 30% | 3% | 3% | 0% |
| ECS-F-341 | 1 | 10/10 (100%) | 9/10 (90%) | 9/10 (90%) | 4/10 (40%) |
| (1.0% spray) | | | | | |
| | 2 | 10/10 (100%) | 8/10 (80%) | 4/10 (40%) | 2/10 (20%) |
| | 3 | * | 4/10 (40%) | 5/10 (50%) | 0/10 (0%) |
| | Mean | 100% | 70% | 60% | 20% |
| ECS-F-342 | 1 | 10/10 (100%) | 4/10 (40%) | 5/10 (50%) | 3/10 (30%) |
| (0.5% spray) | | | | | |
| | 2 | 9/10 (90%) | 3/10 (30%) | 3/10 (30%) | 0/10 (0%) |
| | 3 | 8/10 (80%) | 7/10 (70%) | 3/10 (30%) | 0/10 (0%) |
| | Mean | 90% | 47% | 37% | 10% |
| ECS-F-343 | 1 | 0/10 (0%) | 0/10 (0%) | 2/10 (80%) | 0/10 (0%) |
| (blank spray | | | | | |
| for ECS-F-341 | | | | | |
| and 342 | | | | | |
| | 2 | 0/10 (0%) | 1/10 (0%) | 0/10 (0%) | 0/10 (0%) |
| | 3 | 1/10 (10%) | 0/10 (0%) | 0/10 (0%) | 0/10 (0%) |
| | Mean | 3% | 3% | 7% | 0% |

* These results appear to be an outlier, and therefore, they were not included in the mean calculation.

The results shown in Table No. 15 demonstrate that the varied concentration nootkatone compositions maintained good biocidal activity even at 0.5% nootkatone and the lotions maintained good biocidal activity with or without mineral oil.

### Example No. 5: Pretreatment with Nootkatone Prevents Attachment of Ticks to Skin

### Overview

The exposed skin of mice was pretreated with nootkatone-containing compositions and nymphal hard ticks (Ixodes scapularis) were subsequently introduced onto the treated skin to determine whether nootkatone is effective at preventing ticks from attaching to an animal's skin.

### Experimental Design

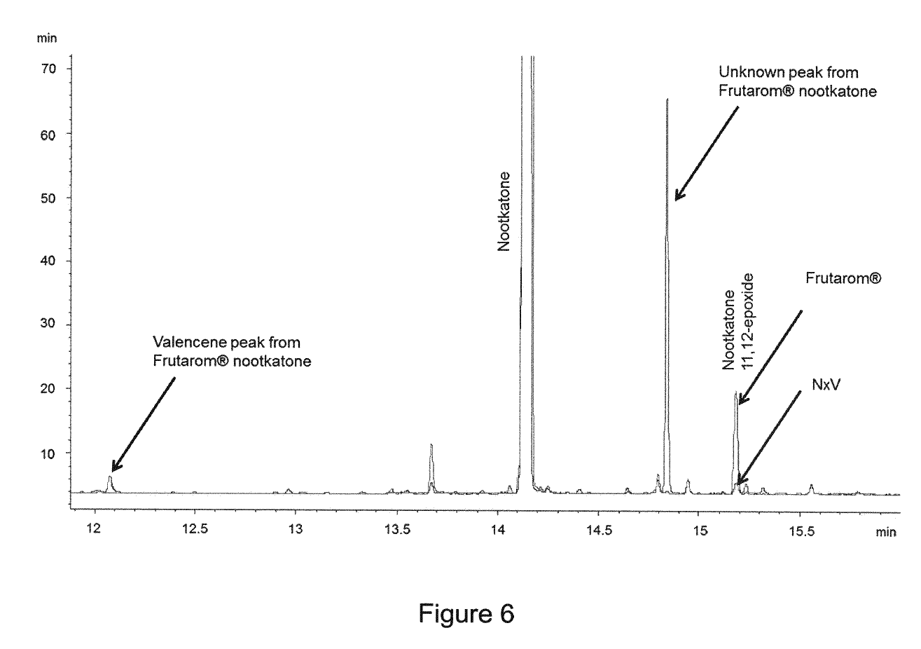

Each of 3 treatment groups included 6 mice. Using a fine blade electric razor hair was removed from the back of each mouse down to the skin. This area was located along the dorsal midline and between the scapulae and the “hind end” of the mouse. A plastic tick-feeding capsule was then glued to the exposed skin of the mouse using a mixture of tree resin and bees wax (see FIG. 5) to form a treatment chamber and contain ticks within the treated area.

Once the capsule glue was dry (after a few seconds drying time), a treatment composition was applied to the exposed skin within each capsule. The nootkatone-containing treatment compositions that were tested included: 1) 25 μL of 2% nootkatone in ethanol (positive control) applied by pipette; 2) a 2% nootkatone lotion (formulation ECS-F-298) applied by a cotton swab; and 3) 25 μL of 2% nootkatone glycerin-based soap applied by pipette, spread out using a cotton swab, and then gently wiped with moist cotton balls to remove some of the soap. After application of the treatment compositions, 5 nymphal ticks infected with the B-31 laboratory strain of Borrelia burgdorferi (Lyme disease spirochete) were placed inside each capsule, and a piece of mesh was glued over the openings to prevent the ticks from escaping. The mice were placed in tick feeding cages consisting of plastic cages that prevented the animals from grooming. Twenty four hours after the ticks were introduced into the capsules, each mouse was anesthetized, and the capsules were removed. Parameters measured included: the number of ticks attached to each mouse, the number of dead ticks, the number of ticks that attached to an area outside of the capsule once it was removed, the number of ticks recovered that were fully fed, and an ear biopsy result to determine transmission of infection.

### Results

As shown in Tables No. 16-18, the data demonstrated that ticks exposed to skin pretreated with any of the three nootkatone (NK) compositions exhibited a greater than 90% repellency rate (the ticks in contact with skin did not attach). Moreover, each treatment composition exhibited acaricidal capacity (killed ticks) of greater than 25%, and fewer than 20% of ticks per treatment group had fully fed. These results demonstrate that nootkatone at a concentration of 2% in either ethanol, lotion, or soap is an effective tick repellent. Moreover, these data further suggest that the tested 2% nootkatone compositions have efficacy for at least a 24 hr period.

TABLE NO. 16
Repellent effect of 2% nootkatone in ethanol

| | | | # ticks | |
|---|---|---|---|---|
| | # ticks | | attached | # ticks |
| | attached | # ticks | outside of | recovered |
| Treatment | at 24 hr | dead | capsule | fully fed |
| 2% NK in | 2/30 | 15/30 | 1/30 | 1/30 |
| EtOH | | | | |
| % change | ↓93.3% | — | — | ↓96.7% |

TABLE NO. 17
Repellent effect of 2% nootkatone lotion (ECS-F-298)

| | | | # ticks | |
|---|---|---|---|---|
| | # ticks | | attached | # ticks |
| | attached | # ticks | outside of | recovered |
| Treatment | at 24 hr | dead | capsule | fully fed |
| 2% NK | 0/30 | 11/30 | 3/30 | 2/30 |
| lotion | (0%) | (36.7%) | (10%) | (6.7%) |
| % change | ↓100% | — | — | ↓93.3% |

TABLE NO. 18
Repellent effect of 2% nootkatone soap

| | | | # ticks | |
|---|---|---|---|---|
| | # ticks | | attached | # ticks |
| | attached | # ticks | outside of | recovered |
| Treatment | at 24 hr | dead | capsule | fully fed |
| 2% NK | 2/30 | 8/30 | 10/30 | 5/30 |
| soap | (6.7%) | (26.7%) | (33.3%) | (16.7%) |
| % change | ↓93.3% | — | — | ↓83.3% |

### Example 6: Nootkatone Treatment Results in Detachment of Ticks Attached to Skin

### Overview

Nymphal hard ticks (Ixodes scapularis) were introduced onto the exposed skin of prepared mice, allowed to attach, and then treated with nootkatone-containing compositions to determine whether nootkatone is effective at causing ticks to detach and kill attached and feeding ticks from an animal's skin.

### Experimental Design

Mice were prepared as described in Example No. 5.

Once the capsule was attached to mice, 5 Lyme disease spirochete-infected nymphal ticks were placed inside each capsule and pieces of mesh were glued over the openings to prevent the ticks from escaping the capsules. The ticks were infected with the Lyme disease spirochete Borrelia burgdorferi laboratory strain B31 maintained in a natural enzootic cycle in laboratory reared tick colonies. Four hours after the ticks were introduced (a period of time that would permit the ticks to attach to the exposed skin within the capsule), each mouse was anesthetized, and the capsules were removed. The number of ticks attached to each mouse's skin within the capsule site was recorded (see Tables No. 19-21 below form all data from Experiment No. 6). At this point, the nootkatone-containing treatment compositions were applied per animal per group as follows: 1) 25 μL of 2% nootkatone in ethanol (positive control) applied by pipette; 2) a 2% nootkatone lotion (formulation ECS-F-298) applied by a cotton swab; and 3) 25 μL of 2% nootkatone glycerin-based soap applied by pipette, spread out using a cotton swab, and then gently wiped with moist cotton balls to remove some of the soap.

Mice were placed in individual tick feeding cages to prevent grooming for 24 hr. The cages were suspended over water, which served as a barrier for ticks and allowed collection of any ticks that fell or dropped from the animals. After 24 hr, mice were again anesthetized, and the numbers of attached ticks and ticks attached outside of capsule area were recorded. Finally, the mice were maintained within their tick feeding cages through 96 hours from introduction of the ticks to identify any “fully fed” tick that maximally fed.

### Results

As shown in Tables No. 19-21, the data demonstrate that treatment of attached and feeding ticks with any of the three nootkatone (NK) compositions exhibited a greater than 75% detachment rate (ticks attached to skin detached themselves when treated within a period of 24 hr). Moreover, both the 2% NK ethanol and 2% NK lotion exhibited a greater than 85% detachment rate over 96 hr. Thus, these results demonstrate that nootkatone at a concentration of 2% in either ethanol, lotion, or soap is an effective treatment for detaching ticks and killing attached and feeding ticks from skin.

TABLE NO. 19
Percent tick detachment with 2% nootkatone in ethanol

| | # ticks | # ticks | # ticks | |
|---|---|---|---|---|
| | attached | attached | attached | # ticks |
| | pre- | in treated | outside of | attached |
| | treatment | area at | capsule | at 96 hr |
| Treatment | at 4 hr | 24 hr | at 48 hr | (fully fed) |
| 2% NK in | 28/30 | 4/30 | 0/30 | 1/30 |
| EtOH | | | | |
| % change | — | ↓85.7% | — | ↓96.4% |

TABLE NO. 20
Percent tick detachment with 2% nootkatone lotion

| | # ticks | | # ticks | |
|---|---|---|---|---|
| | attached | # ticks | attached | # ticks |
| | pre- | attached | outside of | attached |
| | treatment | in treated | capsule | at 96 hr |
| Treatment | at 4 hr | area at 24 hr | at 48 hr | (fully fed) |
| 2% NK | 28/30 | 6/30 | 0/30 | 3/30 |
| lotion | | | | |
| % change | — | ↓78.6% | — | ↓89.3% |

TABLE NO. 21
Percent tick detachment with 2% nootkatone soap

| | # ticks | | # ticks | |
|---|---|---|---|---|
| | attached | # ticks | attached | # ticks |
| | pre- | attached | outside of | attached |
| | treatment | in treated | capsule | at 96 hr |
| Treatment | at 4 hr | area at 24 hr | at 48 h | (fully fed) |
| 2% NK | 30/30 | 6/30 | 4/30 | 9/30* |
| soap | (100%) | | | |
| % change | — | ↓80% | — | ↓70% |

*Note, one mouse experienced tick migration outside of the capsule (treatment area) leading to all 5 ticks being present and fully fed after 96 hr.

### Example No. 7: Comparison of Nootkatone with Citrus-Derived Nootkatone

### Overview

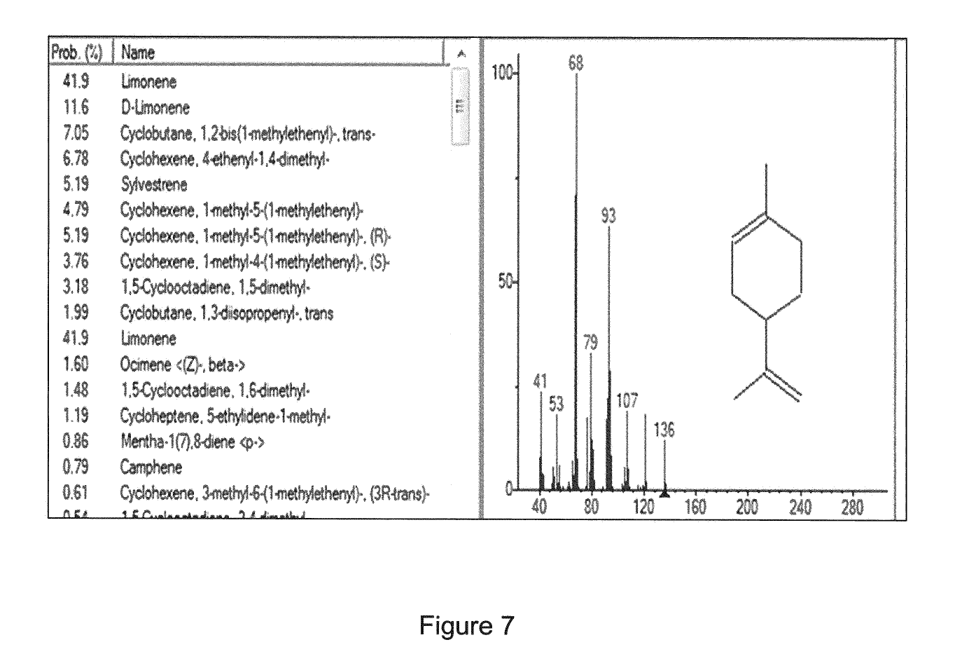

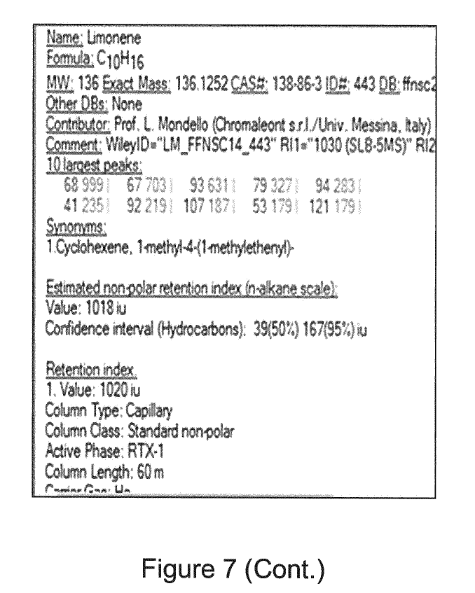

Nootkatone, as defined herein, has a particular chemical profile indicative of its constituent chemical species. Other sources of nootkatone can have different chemical profiles and therefore actually represent different chemical compositions. GC-FID analyses of the nootkatone used in the studies described above (obtained from oxidation of fermentation-derived valencene, also known as, nootkatone ex valencene (NxV)) and a citrus fruit-derived nootkatone (also known as nootkatone ex citrus, which is derived from citrus fruit and available from Frutarom®, Corona, Calif.) are shown in FIG. 6. The nootkatone used in the studies described herein lacked valencene and demonstrated a lower amount of 11,12-epoxide than the Frutarom® nootkatone. Moreover, further analysis of an unknown peak from the Frutarom® nootkatone sample revealed that the Frutarom® sample contained limonene (see FIG. 7), whereas the nootkatone used in the present studies was limonene-free. These results underscore the different chemical profile of the nootkatone used herein (NxV) compared to commercially-available nootkatone derived from citrus, such as that provided by Frutarom®.

These results are also in accord with the observation (not shown) that nootkatone obtained from fermentation-derived valencene does not contain bergapten (or bergaptine), Bergapten (5-methoxypsoralen or 5-MOP) is a compound found in bergamot and citrus essential oils that causes phototoxicity in humans. (Gionfriddo et al. “Elimination of Furocoumarins in Bergamot Peel Oil,” Perfumer & Flavorist., 2004; 29:48-52; Ferreira Maia et al. “Plant-based insect repellents: a review of their efficacy, development and testing,” Malaria Journal, 2011; 10:Suppl1-11; and Kejlová et al. “Phototoxicity of bergamot oil assessed by in vitro techniques in combination with human patch tests.” Toxicol In Vitro. 2007; 21:1298-1303). In addition, GHS health warning statements for bergapten indicate that it can cause allergic skin reactions, allergy or asthma symptoms, or breathing difficulties if inhaled, and can cause genetic defects or cancer in animals. For such reasons, a Cosmetic Ingredient Review expert panel in assessing the safety of 14 citrus-derived peel oil ingredients concluded no more than 0.0015% (15 ppm) bergapten should be included in cosmetic products (see “Safety Assessment of Citrus-Derived Peel Oils as Used in Cosmetics,” Cosmetic Ingredient Review Expert Panel Final Report, Sep. 30, 2014: 1-31).

Bergapten is present in naturally derived valencene (from citrus) and carries over through the chemical oxidation that forms nootkatone. Bergapten can be photo-activated to become a skin irritant, which can be worse around an open bite wound. Bergapten-associated adverse skin reactions around tick bites could mask or give false positives for the preliminary signs of a Lyme disease infection. Therefore, bergapten-free nootkatone obtained from fermentation-derived valencene has particular advantages over plant-derived nootkatone and is preferable for topical application.

### Example 8 Production of Nootkatone ex Valencene

Nootkatone ex valencene may be produced in vivo through expression of one or more enzymes involved in the nootkatone biosynthetic pathway in a recombinant yeast or in vitro using isolated, purified enzymes involved in the nootkatone biosynthetic pathway, such as those described in U.S. Patent Application Publication Nos. 2015/0007368 and 2012/0246767. The final conversion of valencene to nootkatone may be done enzymatically in vivo or in vitro, or may be performed by chemical oxidation (typically inorganic) in vitro.

Briefly, the valencene synthase gene (CVS) from Citrus sinensis cv. Valencia (Valencia orange) was cloned from RNA isolated from the juice vesicles of freshly harvested Valencia orange using the procedure previously described in Example 1 of U.S. Pat. No. 7,442,785.

First, Yep-GW-URA (Takahashi et al,, (2007) Biotechnot Bioeng. 97(1):170-181) was generated by inserting a gateway cloning cassette (RfB) with the form attR1-Cm^{R}-ccdB gene-attR2 (Hartley et al.. (2000) Genome Res, 10:1788-1795) into the Smal restriction site of YEp352-URA (Bio-Technical Resources), which contains an URA3 selectable marker, an ADH1 promoter and an ADH1 terminator flanking, two BamHI sites (one 5′ to the ADH1 promoter and the other 3′ to the ADH terminator), a 2-micron ori, an ampicillin resistance gene and a colE1 origin of replication. The resulting vector was designated YEp-CVS-URA.

The CVS gene (set forth in SEQ ID NO: 1, and encoding amino acid sequence is set forth in SEQ ID NO: 2) was then amplified from RNA isolated from the juice vesicles of freshly harvested Valencia orange to contain restriction sites for subcloning into the yeast shuttle expression vector Yep-GW-URA. Following digestion of Yep-GW-URA with EcoRl and Xbal. the amplified product was cloned into the yeast shuttle expression vector YEp-GW-URA.

The YEp-CVS-ura vector was maintained in S. cerevisiae by selecting on SD minimal medium lacking uracil at 28° C. The vector also was maintained in Escherichia coli by selecting for resistance to ampicillin on LB medium containing 100 μg/mL ampicillin.

To screen for production of valencene, the Saccharomyces cerevisiae yeast cell strains CALI5-1 (ura3, leu2, his3, trpl, Δerg9::HIS3, HMG2cat/TRP1::rDNA, dpp1, sue), ALX7-95 (ura3, his3, trp1, Δerg9::HIS3, HMG2cat/TRP1::rDNA, dpp1, sue) or ALX11-30 (ura3, trp1, erg9def25, HMG2catiTRP1::rDNA, dpp1, sue) were used.

The CALI5-1 strain (see U.S. published Appl. No. US20040249219; U.S. Pat. Nos. 6,531,303 and 6,689,593) has a Δleu2 deletion, which required the introduction of leucine into its media. ALX7-95 was derived from CALI5-1 by correcting the Δleu2 deficiency of CALI5-1 with a functional LEU2 gene (see U.S. published Appl. No. US2010/0151519).

ALX11-30 was constructed from CALI5-1 in several steps from ALX7-175.1 as described in US2010/0151519. Briefly, ALX7-95 HPS was obtained by transforming a plasmid containing the Hyoscyamus muticus premnaspirodiene synthase (HPS) into ALX7-95 strain. The YEp-HPS plasmid was obtained by cloning the gene for HPS into Yep-GW-URA to give YEp-HPS-ura (YEp-HPS). Then, an error prone PCR reaction of the ERG9 gene was performed, and the resulting DNA was transformed into ALX7-95 harboring YEpHPS. Transformants were plated on YP medium lacking ergosterol and screened for premnaspirodiene production. Those that produced high levels of premnaspirodiene were saved. One strain, ALX7-168.25 [ura3, trp1, his3, erg9^{def}25, HMG2cat/TRP1::rDNA, dpp1, sue, YEpHPS] was transformed with a PCR fragment of the complete HIS3 gene to create a functional HIS3 gene. Transformants were isolated that were able to grow in the absence of histidine in the medium. From this transformation, ALX7-175.1 was isolated [ura3, trp1, erg9def25, HMG2cat/TRP1::rDNA, dpp1, sue YEpHPS]. Finally, the plasmid YEpHPS was removed by growing ALX7-175.1 several generations in YPD (10 g/L yeast extract, 20 g/L peptone, 20 g/L glucose) and plating cells on YPD plates. Colonies were identified that were unable to grow on SD medium without uracil (0.67 Bacto yeast nitrogen base without amino acids, 2% glucose, 0.14% yeast synthetic drop-out medium without uracil). This strain was designated ALX11-30.

For screening for production of valencene by valencene synthase or mutants, the YEp-CVS-ura plasmid, containing the CVS gene or modified versions of the CVS gene, was transformed into the above yeast strains using the lithium acetate yeast transformation kit (Sigma-Aldrich). The ALX7-95 and ALX11-30 strains generally produced more valencene than the CALI5-1 strain. CALI5-1 was used for initial screening in vials (as described in Example 3) and production in fermenters. Subsequently. ALX7-95 or ALX11-30 were used for screening in vials and fermenters. Typically, ALX7-95 was used for screening in vials and ALX11-30 was used for fermenters.

Transformants were selected on SDE-ura medium (0.67% Bacto yeast nitrogen base without amino acids, 2% glucose, 0.14% yeast synthetic drop-out medium supplement without uracil, and 40 mg/L ergosterol as needed). Colonies were picked and screened for valencene production using the microculture assay described below.

Production of valencene was performed in a 3-L fermentation tank (New Brunswick Bioflow 110). One liter of fermentation medium was prepared and autoclaved in the fermentation tank (20 g (NH₄)₂SO₄, 20 g KH₂PO₄, 1 g NaCI, MgSO₄.7H₂O, 4 g Solulys corn steep solids (Roquette)). The following components were then added: 20 ml mineral solution (0.028% FeSO₄.7H₂O, 0.029% ZnSO₄.7H₂O, 0.008% CuSO₄.5H₂O, 0.024% Na₂MoO₄.2H₂O, 0.024% CoCl₂.6H₂O, 0.017% MnSO₄.H₂O, 1 mL HCl); 10 mL 50% glucose; 30 mL vitamin solution (0.001% biotin; 0.012% calcium pantothenate, 0.06% inositol, 0.012% pyridoxine-HCl, 0.012% thiamine-HCl); 10 mL 10% CaCl₂, and 20 mL autoclaved soybean oil (purchased from local groceries). For sterol-requiring strains, including CALI5-1 and ALX7-95, 50 mg/L cholesterol or 40 mg/L ergosterol was included in the medium.

The seed culture for inoculating the fermentation medium was prepared by inoculating 50 mL of SDE-ura-trp medium (see Example 3.C.2.) with CALI5-1, ALX7-95 or ALX11-30 containing the YEp-CVS-ura plasmid. This culture was grown at 28° C. until early stationary phase (24-48 hr). One mL of this culture was inoculated into 500 mL of SDE-ura-trp medium and grown for 24 hr at 28° C. A 50-mL aliquot (5% inoculum) was used to inoculate the medium in the fermentation tank.

The fermentor was maintained at 28° C. The air flow was 1 vvm and the dO₂was maintained above 30% by adjusting the agitation. The pH was maintained at 4.5 using phosphoric acid and NaOH or NH₄OH.

When the glucose concentration fell below 1 g/L, a feeding regimen was initiated such that the glucose in the fermentor was kept between 0 and 1 g/L. The glucose feed consisted of 60% glucose (w/v).

At the end of the fermentation, generally about 132 hours after inoculation, sodium sulfate was added to 10-15% final concentration as was an additional 50 mL soybean oil, and the contents of the fermentor were agitated for one hour. After allowing the fermentation vessel contents to settle, the oil was recovered by centrifugation and the valencene content in the oil was determined.

To assay valencene, 3 mL of suspension was placed in a vial to which 3 mL of acetone containing 20 mg/L cedrene was added. After vortexing, the mixture was extracted with 6 mL hexane containing 10 mg/L hexadecane followed by additional vortexing. The organic phase was transferred to a second vial for analysis by gas chromatography using cedrene and hexadecane as internal standards for extraction efficiency and injection, respectively. The CALI5-1, ALX7-95 or ALX11-30 S. cerevisiae containing Yep-CVS-ura, and expressing valencene synthase, was found to produce valencene.

The valencene-containing soybean oil, produced by fermentation as described above, was concentrated and purified using wiped-film distillation at 100° C. and 350 mTorr to generate an oil that contained approximately 68% valencene by weight. This material was converted to nootkatone by two different methods described below.

A. Oxidation of Valencene to Nootkatone Using Chromium Trioxide

The valencene distillate produced as described above was oxidized to nootkatone using chromium trioxide and pyridine in dicholoromethane as follows. Chromium trioxide (369 g, 3.69 mol, 22 eq) was added in portions to a solution of pyridine (584 g, 7.4 mol, 44 eq) in 5 L of dicholoromethane. The mixture was stirred for 10 minutes, 50 grams of valencene distillate (68% w/w, 0.167 mol, 1 eq) was added over four minutes, and the mixture was stirred at 22° C. for 18 hours, The liquor was drained from the vessel, and the solids were washed twice with 2 L of methyl tert-butyl ether (MTBE). The combined organic layers were further diluted with 2 L of MTBE and successively washed three times with 1.25 L of 5% sodium hydroxide, twice with 2 L of 5% hydrochloric acid, and once with 2 L of brine. The organic phase was dried over 200 grams of anhydrous sodium sulfate, filtered, and concentrated by evaporation to give 36.8 grams crude nootkatone (48% w/w, 0.081 mol, 48% yield).

B. Oxidation of Valencene to Nootkatone Using Silica Phosphonate-Immobilized Chromium (III) Catalyst

Silica phosphonate chromium (III) resin (48.9 g, PhosphonicS, Ltd.) was placed in a 5 L round bottom flask equipped with a condenser, thermowell, overhead stirrer, and sparge tube. Two (2) L of t-butanol and valencene distillate (68%, 500 g, 1.67 moles, 1 eq) were added, the contents were heated to 45° C., and the heterogeneous suspension was allowed to stir as oxygen was sparged through the solution (ca 1.5 L/min) and nitrogen flushed over the head-space. 70% t-butyl hydroperoxide in water (TBHP, 315 g, 2.45 moles, 1.47 eq) was added to the solution over 2 hrs while the temperature of the reaction was heated and maintained at 60±5° C. The reaction was allowed to stir until >90% of the valencene was consumed, as determined by gas chromatography. The reaction was then allowed to cool to room temperature and the silica catalyst removed by filtration. The flask and resin were washed with 500 mL isopropanol. One (1) L of deionized water was added to the combined organic solution (t-butanol and isopropanol), and the mixture was concentrated under reduced pressure by evaporation to afford an amber colored oil. The oil was dissolved in 3 L of toluene and washed with 3.125 L of 15% sulfuric acid for 15 minutes with vigorous agitation. The aqueous layer was removed and re-extracted with 1 L of toluene', The combined toluene layers were then washed three times with 2.5 L of 1 M sodium hydroxide, twice with 500 mL saturated sodium chloride, and dried over anhydrous magnesium sulfate. After filtration, the solvent was removed under reduced pressure by evaporation to afford 378 g of viscous amber oil (33% nootkatone by weight, 0.57 moles, 34% yield).

Sequence Listing:

SEQ ID NO: 1 (Citrus valencene synthase)
atgtcgtctggagaaacatttcgtcctactgcagatttccatcctagttt
atggagaaaccatttcctcaaaggtgcttctgatttcaagacagttgatc
atactgcaactcaagaacgacacgaggcactgaaagaagaggtaaggaga
atgataacagatgctgaagataagcctgttcagaagttacgcttgattga
tgaagtacaacgcctgggggtggcttatcactttgagaaagaaatagaag
atgcaatacaaaaattatgtccaatctatattgacagtaatagagctgat
ctccacaccgtttcccttcattttcgattgcttaggcagcaaggaatcaa
gatttcatgtgatgtgtttgagaagttcaaagatgatgagggtagattca
agtcatcgttgataaacgatgttcaagggatgttaagtttgtacgaggca
gcatacatggcagttcgcggagaacatatattagatgaagccattgcttt
cactaccactcacctgaagtcattggtagctcaggatcatgtaaccccta
agcttgcggaacagataaatcatgctttataccgtcctcttcgtaaaacc
ctaccaagattagaggcgaggtattttatgtccatgatcaattcaacaag
tgatcatttatacaataaaactctgctgaattttgcaaagttagatttta
acatattgctagagctgcacaaggaggaactcaatgaattaacaaagtgg
tggaaagatttagacttcactacaaaactaccttatgcaagagacagatt
agtggagttatatttttgggatttagggacatacttcgagcctcaatatg
catttgggagaaagataatgacccaattaaattacatattatccatcata
gatgatacttatgatgcgtatggtacacttgaagaactcagcctctttac
tgaagcagttcaaagatggaatattgaggccgtagatatgcttccagaat
acatgaaattgatttacaggacactcttagatgcttttaatgaaattgag
gaagatatggccaagcaaggaagatcacactgcgtacgttatgcaaaaga
ggagaatcaaaaagtaattggagcatactctgttcaagccaaatggttca
gtgaaggttacgttccaacaattgaggagtatatgcctattgcactaaca
agttgtgcttacacattcgtcataacaaattccttccttggcatgggtga
ttttgcaactaaagaggtttttgaatggatctccaataaccctaaggttg
taaaagcagcatcagttatctgcagactcatggatgacatgcaaggtcat
gagtttgagcagaagagaggacatgttgcgtcagctattgaatgttacac
gaagcagcatggtgtctctaaggaagaggcaattaaaatgtttgaagaag
aagttgcaaatgcatggaaagatattaacgaggagttgatgatgaagcca
accgtcgttgcccgaccactgctcgggacgattcttaatcttgctcgtgc
aattgattttatttacaaagaggacgacggctatacgcattcttacctaa
ttaaagatcaaattgcttctgtgctaggagaccacgttccattttga
SEQ ID NO: 2 (Citrus valencene synthase)
MSSGETFRPTADFHPSLWRNHFLKGASDFKTVDHTATQERHEALKEEVRR
MITDAEDKPVQKLRLIDEVQRLGVAYHFEKEIEDAIQKLCPIYIDSNRAD
LHTVSLHFRLLRQQGIKISCDVFEKEKDDEGRFKSSLINDVQGMLSLYEA
AYMAVRGEHILDEAIAFTTTHLKSLVAQDHVTPKLAEQINHALYRPLRKT
LPRLEARYFMSMINSTSDHLYNKTLLNFAKLDFNILLELHKEELNELTKW
WKDLDFTTKLPYARDRLVELYFWDLGTYFEPQYAFGRKIMTQLNYILSII
DDTYDAYGTLEELSLFTEAVQRWNIEAVDMLPEYMKLIYRTLLDAFNEIE
EDMAKQGRSHCVRYAKEENQKVIGAYSVQAKWFSEGYVPTIEEYMPIALT
SCAYTFVITNSFLGMGDFATKEVFEWISNNPKVVKAASVICRLMDDMQGH
EFEQKRGHVASAIECYTKQHGVSKEEAIKMFEEEVANAWKDINEELMMKP
TVVARPLLGTILNLARAIDFIYKEDDGYTHSYLIKDQIASVLGDHVPF

Having described the invention in detail and by reference to specific embodiments thereof, it will be apparent that modifications and variations are possible without departing from the scope of the invention defined in the appended claims. More specifically, although some aspects of the present invention are identified herein as particularly advantageous, it is contemplated that the present invention is not necessarily limited to these particular aspects of the invention. Percentages disclosed herein may otherwise vary in amount by ±10, 20, or 30% from values disclosed herein.

What is claimed is:

1. A method for detaching a tick attached to skin of a subject, comprising the steps of:
applying a therapeutically effective amount of nootkatone to the attached tick; and
detaching the tick from the skin of the subject.

2. A method of preventing tick attachment, or for detaching or killing attached and feeding ticks from skin of an animal, comprising applying a therapeutically effective amount of a nootkatone-containing composition to the animal,
wherein the composition comprises nootkatone ex valencene.

3. The method of claim 2, wherein nootkatone is applied to an exterior surface of the animal.

4. The method of claim 2 or 3, wherein the exterior surface is one or more of fur, hair, skin, hide, or scalp.

5. The method according to any of the preceding claims further comprising the step of removing the tick from the skin of the animal.

6. The method of claim 5 further comprising applying the nootkatone-containing composition to the tick.

7. A method for preventing the attachment of a tick to the skin of a subject, comprising the steps of:
applying a composition comprising a therapeutically effective amount of nootkatone formulated for topical administration to the skin of the subject; and
preventing the attachment of a tick that contacts the skin of the subject.

8. A method for detaching a tick from skin, comprising the steps of:
providing a composition comprising at least 2% nootkatone formulated for topical administration;
applying the composition to a tick attached to a subject's skin; and
detaching the tick from the skin.

9. A method for removing a tick attached to a subject's skin, comprising:
providing a composition comprising at least 2% nootkatone formulated for topical administration; and
applying the composition to the subject's skin,
wherein application of the composition to the skin causes the attached tick to detach from the skin.

10. The method of any of claim 2, 3, 4, 5, 6, 7, 8, or 9, wherein the composition comprising nootkatone is an aerosol, a solution, an emulsion, an oil, a lotion, a soap, a shampoo, a conditioner, a spray, a gel, a cosmetic, a perfume, or a cologne.

11. The method of any of claim 2, 3, 4, 5, 6, 7, 8, 9, or 10, wherein the composition comprising nootkatone formulated for topical administration comprises a carrier.

12. The method of claim 11, wherein the carrier comprises an aqueous liquid carrier, water, a gel, a powder, a zeolite, a cellulosic material, a microcapsule, an alcohol such as ethanol, a hydrocarbon, a fat, and/or an oil, and mixtures thereof.

13. The method of any claim 2, 3, 4, 5, 6, 7, 8, 9, 10, 11, or 12, wherein the composition comprising nootkatone comprises one or more of a fragrance, a preservative, a propellant, a pH buffering agent, a colorant, a surfactant, an emulsifier, a solvent, an antibiotic, an analgesic, a sanitizer, and/or a salt, and mixtures thereof.

14. A method of preventing tick attachment to or detaching a tick from skin of an animal, comprising applying a composition to the animal, the composition comprising
from about 0.01% to about 75% nootkatone;
0 to about 30% additional active ingredient;
0 to about 50% additive; and
a carrier.

15. The method of claim 14, wherein the composition comprises at least about 2% to about 10% nootkatone.

25. The composition according to any of claim 21, 22, 23, or 24, wherein the composition comprises a 2% nootkatone lotion.

26. The composition according to any of claim 21, 22, 23, or 24, wherein the composition comprises a 2% nootkatone soap.

27. The composition of claim 26, wherein the composition further comprises glycerin.

28. The composition according to any of claim 21, 22, 23, 24, 25, 26, or 27 wherein the composition comprises 2% nootkatone and 98% carrier.

29. The composition of claim 21, 22, 23, 24, 25, 26, 27, or 28, wherein the carrier comprises ethanol.

30. The composition or method of any of the preceding claims, wherein the nootkatone is nootkatone ex valencene.

31. The composition or method of any of the preceding claims, wherein the nootkatone is bergapten-free.

32. The composition or method according to any of the preceding claims, wherein the nootkatone is limonene-free.

16. The method of claim 15, wherein the composition comprises about 1% to about 30% of an additional active ingredient.

17. The method of claim 16, wherein the composition comprises about 1% to about 50% of an additive.

18. The method of claim 17, wherein the additive is one or more of an antibiotic and an analgesic.

19. The method of any of claim 2, 3, 4, 5, 6, 7, 8, 9, 10, 11, 12, 13, 14, 15, 16, 17, or 18, wherein the animal is a human, a mammal, a bird, or a reptile.

20. A method of detaching a parasite from a surface, comprising:
applying a formulation comprising at least 2% nootkatone to the surface,
wherein the parasite has been attached to the surface for a period of time longer than about 10 minutes.

21. A composition for detaching ticks from a human or animal, comprising:
about 2% to about 75% nootkatone;
0 to about 30% of an additional active ingredient;
0 to about 50% of an additive; and
a carrier.

22. The composition of claim 21, wherein the composition comprises about 1% to about 30% of an additional active ingredient.

23. The composition according to any of claim 21 or 22, wherein the composition comprises about 1% to about 50% of an additive.

24. The composition of claim 23, wherein the additive is one or more of an antibiotic and an analgesic.


SEQUENCE LISTING (2 sequences)

SEQ ID NO: 1 - DNA, 1647 bp, Citrus sinensis
atgtcgtctggagaaacatttcgtcctactgcagatttccatcctagtttatggagaaaccatttcctcaaaggtgcttctgatttcaagacagttgatcatactgcaactcaagaacgacacgaggcactgaaagaagaggtaaggagaatgataacagatgctgaagataagcctgttcagaagttacgcttgattgatgaagtacaacgcctgggggtggcttatcactttgagaaagaaatagaagatgcaatacaaaaattatgtccaatctatattgacagtaatagagctgatctccacaccgtttcccttcattttcgattgcttaggcagcaaggaatcaagatttcatgtgatgtgtttgagaagttcaaagatgatgagggtagattcaagtcatcgttgataaacgatgttcaagggatgttaagtttgtacgaggcagcatacatggcagttcgcggagaacatatattagatgaagccattgctttcactaccactcacctgaagtcattggtagctcaggatcatgtaacccctaagcttgcggaacagataaatcatgctttataccgtcctcttcgtaaaaccctaccaagattagaggcgaggtattttatgtccatgatcaattcaacaagtgatcatttatacaataaaactctgctgaattttgcaaagttagattttaacatattgctagagctgcacaaggaggaactcaatgaattaacaaagtggtggaaagatttagacttcactacaaaactaccttatgcaagagacagattagtggagttatatttttgggatttagggacatacttcgagcctcaatatgcatttgggagaaagataatgacccaattaaattacatattatccatcatagatgatacttatgatgcgtatggtacacttgaagaactcagcctctttactgaagcagttcaaagatggaatattgaggccgtagatatgcttccagaatacatgaaattgatttacaggacactcttagatgcttttaatgaaattgaggaagatatggccaagcaaggaagatcacactgcgtacgttatgcaaaagaggagaatcaaaaagtaattggagcatactctgttcaagccaaatggttcagtgaaggttacgttccaacaattgaggagtatatgcctattgcactaacaagttgtgcttacacattcgtcataacaaattccttccttggcatgggtgattttgcaactaaagaggtttttgaatggatctccaataaccctaaggttgtaaaagcagcatcagttatctgcagactcatggatgacatgcaaggtcatgagtttgagcagaagagaggacatgttgcgtcagctattgaatgttacacgaagcagcatggtgtctctaaggaagaggcaattaaaatgtttgaagaagaagttgcaaatgcatggaaagatattaacgaggagttgatgatgaagccaaccgtcgttgcccgaccactgctcgggacgattcttaatcttgctcgtgcaattgattttatttacaaagaggacgacggctatacgcattcttacctaattaaagatcaaattgcttctgtgctaggagaccacgttccattttga

SEQ ID NO: 2 - protein, 548 aa, Citrus sinensis
MSSGETFRPTADFHPSLWRNHFLKGASDFKTVDHTATQERHEALKEEVRRMITDAEDKPVQKLRLIDEVQRLGVAYHFEKEIEDAIQKLCPIYIDSNRADLHTVSLHFRLLRQQGIKISCDVFEKFKDDEGRFKSSLINDVQGMLSLYEAAYMAVRGEHILDEAIAFTTTHLKSLVAQDHVTPKLAEQINHALYRPLRKTLPRLEARYFMSMINSTSDHLYNKTLLNFAKLDFNILLELHKEELNELTKWWKDLDFTTKLPYARDRLVELYFWDLGTYFEPQYAFGRKIMTQLNYILSIIDDTYDAYGTLEELSLFTEAVQRWNIEAVDMLPEYMKLIYRTLLDAFNEIEEDMAKQGRSHCVRYAKEENQKVIGAYSVQAKWFSEGYVPTIEEYMPIALTSCAYTFVITNSFLGMGDFATKEVFEWISNNPKVVKAASVICRLMDDMQGHEFEQKRGHVASAIECYTKQHGVSKEEAIKMFEEEVANAWKDINEELMMKPTVVARPLLGTILNLARAIDFIYKEDDGYTHSYLIKDQIASVLGDHVPF